(19) United States
(12) Patent Application Publication
(10) Pub. No.: US 2016/0241369 A1
(43) Pub. Date: Aug. 18, 2016

(54) TONE PLANS AND INTERLEAVER PARAMETERS FOR WIRELESS COMMUNICATION NETWORKS

(71) Applicant: QUALCOMM Incorporated, San Diego, CA (US)

(72) Inventors: Lin Yang, San Diego, CA (US); Bin Tian, San Diego, CA (US); Jialing Li Chen, San Diego, CA (US)

(21) Appl. No.: 15/019,808

(22) Filed: Feb. 9, 2016

Related U.S. Application Data
(60) Provisional application No. 62/116,331, filed on Feb. 13, 2015.
(60) Provisional application No. 62/159,066, filed on May 8, 2015.

(51) Int. Cl. H04L 5/00; H04L 25/02

(52) U.S. Cl. CPC H04L 5/0048; H04L 25/0232

(57) ABSTRACT

Methods and apparatuses for providing wireless messages according to various tone plans can include a method of wireless communication. The method can include generating, at a wireless device, an 80 MHz single-user message for transmission over 996 usable tones including 980 data tones and 16 pilot tones. The method further can include interleaving data for transmission on the data tones using an interleaver depth of using an interleaver depth of 2, 4, 5, 7, 10, 14, 20, 28, 35, 49, 70, 98, 140, 196, 245, or 290. The method further can include transmitting the message.

### PRIORITY CLAIM

This application claims the benefit of U.S. Provisional Application No. 62/116,331, filed Feb. 13, 2015; and U.S. Provisional Application No. 62/159,066, filed May 8, 2015, each of which is hereby incorporated herein by reference in its entirety.

### FIELD

Certain aspects of the present disclosure generally relate to wireless communications, and more particularly, to methods and apparatuses for providing messages according to various tone plans and interleaver parameters.

### BACKGROUND

In many telecommunication systems, communications networks are used to exchange messages among several interacting spatially-separated devices. Networks can be classified according to geographic scope, which could be, for example, a metropolitan area, a local area, or a personal area. Such networks can be designated respectively as a wide area network (WAN), metropolitan area network (MAN), local area network (LAN), or personal area network (PAN). Networks also differ according to the switching/routing technique used to interconnect the various network nodes and devices (e.g., circuit switching vs. packet switching), the type of physical media employed for transmission (e.g., wired vs. wireless), and the set of communication protocols used (e.g., Internet protocol suite, SONET (Synchronous Optical Networking), Ethernet, etc.).

Wireless networks are often preferred when the network elements are mobile and thus have dynamic connectivity needs, or if the network architecture is formed in an ad hoc, rather than fixed, topology. Wireless networks employ intangible physical media in an unguided propagation mode using electromagnetic waves in the radio, microwave, infra-red, optical, etc. frequency bands. Wireless networks advantageously facilitate user mobility and rapid field deployment when compared to fixed wired networks.

The devices in a wireless network can transmit/receive information between each other. Device transmissions can interfere with each other, and certain transmissions can selectively block other transmissions. Where many devices share a communication network, congestion and inefficient link usage can result. As such, systems, methods, and non-transitory computer-readable media are needed for improving communication efficiency in wireless networks.

### SUMMARY

Various implementations of systems, methods and devices within the scope of the appended claims each have several aspects, no single one of which is solely responsible for the desirable attributes described herein. Without limiting the scope of the appended claims, some features are described herein.

One aspect of the present disclosure provides a method of wireless communication.

The method includes generating, at a wireless device, an 80 MHz single-user message for transmission over 996 usable tones including 980 data tones and 16 pilot tones. The method further includes interleaving data for transmission on the data tones using an interleaver depth of using an interleaver depth of 2, 4, 5, 7, 10, 14, 20, 28, 35, 49, 70, 98, 140, 196, 245, or 290. The method further includes transmitting the message.

In various embodiments, the method can further include transmitting 16 pilot signals that change in frequency a number of times according to a sequence that repeats according to a channel interpolation factor of 2 or greater. In various embodiments, the method can further include boosting a transmit power of the pilot signals by a number of dB. In various embodiments, the number of dB can be 3 or 6. In various embodiments, the channel interpolation factor can be 4.

In various embodiments, said interleaving can include a two-step interleaving process including distributing the data to a plurality of sub-bands, and separately interleaving each sub-band. In various embodiments, the method can be performed by an access point serving at least one mobile station. A processor and memory of the access point can be configured to transmit the message to the mobile station through a transmitter and antenna of the access point. In various embodiments, the method can be performed by a mobile station served by an access point. A processor and memory of the mobile device can be configured to transmit the message to the access point through a transmitter and antenna of the mobile device.

Another aspect provides an apparatus configured to provide wireless communication. The apparatus includes a memory that stores instructions. The apparatus further includes a processor coupled with the memory. The processor and the memory can be configured to generate an 80 MHz single-user message for transmission over 996 usable tones including 980 data tones and 16 pilot tones. The processor and the memory can be further configured to interleave data for transmission on the data tones using an interleaver depth of using an interleaver depth of 2, 4, 5, 7, 10, 14, 20, 28, 35, 49, 70, 98, 140, 196, 245, or 290. The apparatus further includes a transmitter configured to transmit the message.

In various embodiments, the processor and the memory can be further configured to transmit 16 pilot signals that change in frequency a number of times according to a sequence that repeats according to a channel interpolation factor of 2 or greater. In various embodiments, the processor and the memory can be further configured to boost a transmit power of the pilot signals by a number of dB. In various embodiments, the number of dB can be 3 or 6. In various embodiments, the channel interpolation factor can be 4.

In various embodiments, said interleaving can include a two-step interleaving process. The processor and the memory can be further configured to distribute the data to a plurality of sub-bands, and separately interleave each sub-band. In various embodiments, the apparatus can include an access point serving at least one mobile station. The processor and memory can be configured to transmit the message to the at least one mobile station through the transmitter and an antenna of the access point. In various embodiments, the apparatus can include a mobile station served by an access point. The processor and memory can be configured of the mobile device can be configured to transmit the message to the access point through a transmitter and antenna of the mobile device.

Another aspect provides another apparatus for wireless communication. The apparatus includes means for generating an 80 MHz single-user message for transmission over 996 usable tones including 980 data tones and 16 pilot tones. The apparatus further includes means for interleaving data for transmission on the data tones using an interleaver depth of using an interleaver depth of 2, 4, 5, 7, 10, 14, 20, 28, 35, 49, 70, 98, 140, 196, 245, or 290. The apparatus further includes means for transmitting the message.

In various embodiments, the apparatus can further include means for transmitting 16 pilot signals that change in frequency a number of times according to a sequence that repeats according to a channel interpolation factor of 2 or greater. In various embodiments, the apparatus can further include means for boosting a transmit power of the pilot signals by a number of dB. In various embodiments, the number of dB can be 3 or 6. In various embodiments, the channel interpolation factor can be 4.

In various embodiments, said means for interleaving can include means for two-step interleaving process including means for distributing the data to a plurality of sub-bands, and means for separately interleaving each sub-band. In various embodiments, the apparatus can include an access point serving at least one mobile station. The processor and memory can be configured to transmit the message to the at least one mobile station through the transmitter and an antenna of the access point. In various embodiments, the apparatus can include a mobile station served by an access point. The processor and memory can be configured of the mobile device can be configured to transmit the message to the access point through a transmitter and antenna of the mobile device.

Another aspect provides a non-transitory computer-readable medium. The medium includes code that, when executed, causes an apparatus to generate an 80 MHz single-user message for transmission over 996 usable tones including 980 data tones and 16 pilot tones. The medium further includes code that, when executed, causes the apparatus to interleave data for transmission on the data tones using an interleaver depth of using an interleaver depth of 2, 4, 5, 7, 10, 14, 20, 28, 35, 49, 70, 98, 140, 196, 245, or 290. The medium further includes code that, when executed, causes the apparatus to transmit the message.

In various embodiments, the medium can further include code that, when executed, causes the apparatus to transmit 16 pilot signals that change in frequency a number of times according to a sequence that repeats according to a channel interpolation factor of 2 or greater. In various embodiments, the medium can further include code that, when executed, causes the apparatus to boost a transmit power of the pilot signals by a number of dB. In various embodiments, the number of dB can be 3 or 6. In various embodiments, the channel interpolation factor can be 4.

In various embodiments, the medium can further include code that, when executed, causes the apparatus to interleave the data using a two-step interleaving process by distributing the data to a plurality of sub-bands, and separately interleaving each sub-band. In various embodiments, the apparatus can include an access point serving at least one mobile station. The processor and memory can be configured to transmit the message to the at least one mobile station through the transmitter and an antenna of the access point. In various embodiments, the apparatus can include a mobile station served by an access point. The processor and memory can be configured of the mobile device can be configured to transmit the message to the access point through a transmitter and antenna of the mobile device.

Another aspect of the present disclosure provides a method of wireless communication. The method includes generating, at a wireless device, an 80 MHz single-user message for transmission over one of 994, 996, or 998 usable tones. The method further includes performing two-step interleaving. Performing two-step interleaving includes distributing data to a plurality of sub-bands and interleaving each sub-band. The method further includes transmitting the message.

In various embodiments, interleaving each sub-band can further include one or more of: using an interleaver depth of 2, 3, 6, 163, 326, or 489 for a 978 data tone block, using an interleaver depth of 2, 4, 5, 7, 10, 14, 20, 28, 35, 49, 70, 98, 140, 196, 245, or 290 for a 980 data tone block, using an interleaver depth of 2 or 491 for a 982 data tone block, using an interleaver depth of 2, 3, 4, 6, 8, 12, 24, 41, 82, 123, 164, 246, 328, or 492 for a 984 data tone block, using an interleaver depth of 2, 17, 29, 34, 58, or 493 a 986 data tone block, using an interleaver depth of 2, 4, 13, 19, 26, 38, 52, 76, 247, or 494 for a 988 data tone block, or using an interleaver depth of 2, 3, 5, 6, 9, 10, 11, 15, 18, 22, 30, 33, 45, 55, 66, 90, 99, 110, 165, 198, 330 or 495 for a 990 data tone block.

In various embodiments, the method can further include transmitting 32, 33, 34, 36, or 37 pilot signals that change in frequency a number of times according to a sequence that repeats according to a channel interpolation factor of 2.

In various embodiments, interleaving each sub-band can further include one or more of: using an interleaver depth of 2, 3, 4, 6, 8, 10, 12, 15, 16, 20, 24, 30, 32, 40, 48, 60, 64, 80, 96, 120, 160, 192, 240, 320, or 480 for a 960 data tone block, using an interleaver depth of 2, 13, 26, 37, 74, or 481 for a 962 data tone block, using an interleaver depth of 2, 4, 241, or 482 for a 964 data tone block, or using an interleaver depth of 2, 3, 6, 7, 14, 21, 23, 42, 46, 69, 138, 161, 322, or 483 for a 966 data tone block.

In various embodiments, the method can further include transmitting 16 or fewer pilot signals that change in frequency a number of times according to a sequence that repeats according to a channel interpolation factor of 2 or greater. In various embodiments, the method can further include boosting a transmit power of the pilot signals by a number of dB. In various embodiments, the number of dB can be 3 or 6. In various embodiments, the number of pilot signals can be 16 and the channel interpolation factor can be 4.

Another aspect provides an apparatus configured to perform wireless communication. The apparatus includes a processor configured to generate an 80 MHz single-user message for transmission over one of 994, 996, or 998 usable tones. The processor is further configured to perform two-step interleaving by distributing data to a plurality of sub-bands and interleaving each sub-band. The apparatus further includes a transmitter configured to transmit the message.

In various embodiments, the processor can be configured to interleave each sub-band by being configured to use an interleaver depth of 2, 3, 6, 163, 326, or 489 for a 978 data tone block, use an interleaver depth of 2, 4, 5, 7, 10, 14, 20, 28, 35, 49, 70, 98, 140, 196, 245, or 290 for a 980 data tone block, use an interleaver depth of 2 or 491 for a 982 data tone block, use an interleaver depth of 2, 3, 4, 6, 8, 12, 24, 41, 82, 123, 164, 246, 328, or 492 for a 984 data tone block, use an interleaver depth of 2, 17, 29, 34, 58, or 493 a 986 data tone block, use an interleaver depth of 2, 4, 13, 19, 26, 38, 52, 76, 247, or 494 for a 988 data tone block, or use an interleaver depth of 2, 3, 5, 6, 9, 10, 11, 15, 18, 22, 30, 33, 45, 55, 66, 90, 99, 110, 165, 198, 330 or 495 for a 990 data tone block.

In various embodiments, the transmitter is further configured to transmit 32, 33, 34, 36, or 37 pilot signals that change in frequency a number of times according to a sequence that repeats according to a channel interpolation factor of 2.

In various embodiments, the processor can be configured to interleave each sub-band by being configured to use an interleaver depth of 2, 3, 4, 6, 8, 10, 12, 15, 16, 20, 24, 30, 32, 40, 48, 60, 64, 80, 96, 120, 160, 192, 240, 320, or 480 for a 960 data tone block, use an interleaver depth of 2, 13, 26, 37, 74, or 481 for a 962 data tone block, use an interleaver depth of 2, 4, 241, or 482 for a 964 data tone block, or use an interleaver depth of 2, 3, 6, 7, 14, 21, 23, 42, 46, 69, 138, 161, 322, or 483 for a 966 data tone block.

In various embodiments, the transmitter can be further configured to transmit 16 or fewer pilot signals that change in frequency a number of times according to a sequence that repeats according to a channel interpolation factor of 2 or greater. In various embodiments, the transmitter can be further configured to boost a transmit power of the pilot signals by a number of dB. In various embodiments, the number of dB can be 3 or 6. In various embodiments, the number of pilot signals can be 16 and the channel interpolation factor can be 4.

Another aspect provides another apparatus for wireless communication. The apparatus includes means for generating an 80 MHz single-user message for transmission over one of 994, 996, or 998 usable tones. The apparatus further includes means for performing two-step interleaving. The means for performing two-step interleaving includes means for distributing data to a plurality of sub-bands and means for interleaving each sub-band. The apparatus further includes means for transmitting the message.

In various embodiments, means for interleaving each sub-band can further include means for using an interleaver depth of 2, 3, 6, 163, 326, or 489 for a 978 data tone block, means for using an interleaver depth of 2, 4, 5, 7, 10, 14, 20, 28, 35, 49, 70, 98, 140, 196, 245, or 290 for a 980 data tone block, means for using an interleaver depth of 2 or 491 for a 982 data tone block, means for using an interleaver depth of 2, 3, 4, 6, 8, 12, 24, 41, 82, 123, 164, 246, 328, or 492 for a 984 data tone block, means for using an interleaver depth of 2, 17, 29, 34, 58, or 493 a 986 data tone block, means for using an interleaver depth of 2, 4, 13, 19, 26, 38, 52, 76, 247, or 494 for a 988 data tone block, or means for using an interleaver depth of 2, 3, 5, 6, 9, 10, 11, 15, 18, 22, 30, 33, 45, 55, 66, 90, 99, 110, 165, 198, 330 or 495 for a 990 data tone block.

In various embodiments, the apparatus can further include means for transmitting 32, 33, 34, 36, or 37 pilot signals that change in frequency a number of times according to a sequence that repeats according to a channel interpolation factor of 2.

In various embodiments, means for interleaving each sub-band can further include means for using an interleaver depth of 2, 3, 4, 6, 8, 10, 12, 15, 16, 20, 24, 30, 32, 40, 48, 60, 64, 80, 96, 120, 160, 192, 240, 320, or 480 for a 960 data tone block, means for using an interleaver depth of 2, 13, 26, 37, 74, or 481 for a 962 data tone block, means for using an interleaver depth of 2, 4, 241, or 482 for a 964 data tone block, or means for using an interleaver depth of 2, 3, 6, 7, 14, 21, 23, 42, 46, 69, 138, 161, 322, or 483 for a 966 data tone block.

In various embodiments, the apparatus can further include means for transmitting 16 or fewer pilot signals that change in frequency a number of times according to a sequence that repeats according to a channel interpolation factor of 2 or greater. In various embodiments, the apparatus can further include means for boosting a transmit power of the pilot signals by a number of dB. In various embodiments, the number of dB can be 3 or 6. In various embodiments, the number of pilot signals can be 16 and the channel interpolation factor can be 4.

Another aspect provides a non-transitory computer-readable medium. The medium includes code that, when executed, causes an apparatus to generate an 80 MHz single-user message for transmission over one of 994, 996, or 998 usable tones. The medium further includes code that, when executed, causes the apparatus to perform two-step interleaving by distributing data to a plurality of sub-bands and interleaving each sub-band. The medium further includes code that, when executed, causes the apparatus to transmit the message.

In various embodiments, interleaving each sub-band can further include one or more of: using an interleaver depth of 2, 3, 6, 163, 326, or 489 for a 978 data tone block, using an interleaver depth of 2, 4, 5, 7, 10, 14, 20, 28, 35, 49, 70, 98, 140, 196, 245, or 290 for a 980 data tone block, using an interleaver depth of 2 or 491 for a 982 data tone block, using an interleaver depth of 2, 3, 4, 6, 8, 12, 24, 41, 82, 123, 164, 246, 328, or 492 for a 984 data tone block, using an interleaver depth of 2, 17, 29, 34, 58, or 493 a 986 data tone block, using an interleaver depth of 2, 4, 13, 19, 26, 38, 52, 76, 247, or 494 for a 988 data tone block, or using an interleaver depth of 2, 3, 5, 6, 9, 10, 11, 15, 18, 22, 30, 33, 45, 55, 66, 90, 99, 110, 165, 198, 330 or 495 for a 990 data tone block.

In various embodiments, the medium can further include code that, when executed, causes the medium to transmit 32, 33, 34, 36, or 37 pilot signals that change in frequency a number of times according to a sequence that repeats according to a channel interpolation factor of 2.

In various embodiments, interleaving each sub-band can further include one or more of: using an interleaver depth of 2, 3, 4, 6, 8, 10, 12, 15, 16, 20, 24, 30, 32, 40, 48, 60, 64, 80, 96, 120, 160, 192, 240, 320, or 480 for a 960 data tone block, using an interleaver depth of 2, 13, 26, 37, 74, or 481 for a 962 data tone block, using an interleaver depth of 2, 4, 241, or 482 for a 964 data tone block, or using an interleaver depth of 2, 3, 6, 7, 14, 21, 23, 42, 46, 69, 138, 161, 322, or 483 for a 966 data tone block.

In various embodiments, the medium can further include code that, when executed, causes the apparatus to transmit 16 or fewer pilot signals that change in frequency a number of times according to a sequence that repeats according to a channel interpolation factor of 2 or greater. In various embodiments, the medium can further include code that, when executed, causes the apparatus to boost a transmit power of the pilot signals by a number of dB. In various embodiments, the number of dB can be 3 or 6. In various embodiments, the number of pilot signals can be 16 and the channel interpolation factor can be 4.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 illustrates an example of a wireless communication system in which aspects of the present disclosure can be employed.

FIG. 2 illustrates various components that can be utilized in a wireless device that can be employed within the wireless communication system of FIG. 1.

FIG. 3 shows an example 2N-tone plan, according to one embodiment.

FIG. 4 is a chart illustrating candidate interleaver parameters for different numbers of data tones, according to a 994-, 996-, or 998-tone plan embodiment.

FIG. 5 is a chart illustrating a low density parity check (LDPC) tone mapping distance (DTM) for different numbers of data tones (Ndata).

FIG. 6 is a diagram illustrating various walking pilot parameters.

FIG. 7 is a chart illustrating walking pilot parameters according to various embodiments.

FIG. 8 is a chart illustrating candidate interleaver parameters for different numbers of data tones, according to a 960-, 962-, 964-, or 966-tone plan embodiment.

FIG. 9 is a chart illustrating a low density parity check (LDPC) tone mapping distance (D_{TM}) for different numbers of data tones (N_{data}).

FIG. 10 shows a system that is operable to generate interleaving parameters for orthogonal frequency-division multiple access (OFDMA) tone plans, according to an embodiment.

FIG. 11 shows an exemplary multiple-input-multiple-output (MIMO) system that can be implemented in wireless devices, such as the wireless device of FIG. 10, to transmit and receive wireless communications.

FIG. 12 shows a flowchart of an exemplary method of wireless communication that can be employed within the wireless communication system of FIG. 1.

FIG. 13 shows a simulation of packet error rates (PER) according to various embodiments.

FIG. 14 shows a flowchart of another exemplary method of wireless communication that can be employed within the wireless communication system of FIG. 1.

### DETAILED DESCRIPTION

Various aspects of the novel systems, apparatuses, and methods are described more fully hereinafter with reference to the accompanying drawings. The teachings of this disclosure can, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently of or combined with any other aspect of the invention. For example, an apparatus can be implemented or a method can be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein can be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

### Implementing Devices

Wireless network technologies can include various types of wireless local area networks (WLANs). A WLAN can be used to interconnect nearby devices together, employing widely used networking protocols. The various aspects described herein can apply to any communication standard, such as Wi-Fi or, more generally, any member of the IEEE 802.11 family of wireless protocols.

In some aspects, wireless signals can be transmitted according to a high-efficiency 802.11 protocol using orthogonal frequency-division multiplexing (OFDM), direct-sequence spread spectrum (DSSS) communications, a combination of OFDM and DSSS communications, or other schemes.

In some implementations, a WLAN includes various devices which are the components that access the wireless network. For example, there can be two types of devices: access points (“APs”) and clients (also referred to as stations, or “STAs”). In general, an AP serves as a hub or base station for the WLAN and an STA serves as a user of the WLAN. For example, an STA can be a laptop computer, a personal digital assistant (PDA), a mobile phone, etc. In an example, an STA connects to an AP via a Wi-Fi (e.g., IEEE 802.11 protocol such as 802.11ax) compliant wireless link to obtain general connectivity to the Internet or to other wide area networks. In some implementations an STA can also be used as an AP.

The techniques described herein can be used for various broadband wireless communication systems, including communication systems that are based on an orthogonal multiplexing scheme. Examples of such communication systems include Spatial Division Multiple Access (SDMA), Time Division Multiple Access (TDMA), Orthogonal Frequency Division Multiple Access (OFDMA) systems, Single-Carrier Frequency Division Multiple Access (SC-FDMA) systems, and so forth. An SDMA system can utilize sufficiently different directions to concurrently transmit data belonging to multiple user terminals. A TDMA system can allow multiple user terminals to share the same frequency channel by dividing the transmission signal into different time slots, each time slot being assigned to different user terminal. A TDMA system can implement GSM or some other standards known in the art. An OFDMA system utilizes orthogonal frequency division multiplexing (OFDM), which is a modulation technique that partitions the overall system bandwidth into multiple orthogonal sub-carriers. These sub-carriers can also be called tones, bins, etc. With OFDM, each sub-carrier can be independently modulated with data. An OFDM system can implement IEEE 802.11 or some other standards known in the art. An SC-FDMA system can utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA. A SC-FDMA system can implement 3GPP-LTE (3rd Generation Partnership Project Long Term Evolution) or other standards.

The teachings herein can be incorporated into (e.g., implemented within or performed by) a variety of wired or wireless apparatuses (e.g., nodes). In some aspects, a wireless node implemented in accordance with the teachings herein can comprise an access point or an access terminal.

An access point (“AP”) can comprise, be implemented as, or known as a NodeB, Radio Network Controller (“RNC”), eNodeB, Base Station Controller (“BSC”), Base Transceiver Station (“BTS”), Base Station (“BS”), Transceiver Function (“TF”), Radio Router, Radio Transceiver, Basic Service Set (“BSS”), Extended Service Set (“ESS”), Radio Base Station (“RBS”), or some other terminology.

A station (“STA”) can also comprise, be implemented as, or known as a user terminal, an access terminal (“AT”), a subscriber station, a subscriber unit, a mobile station, a remote station, a remote terminal, a user agent, a user device, user equipment, or some other terminology. In some implementations an access terminal can comprise a cellular telephone, a cordless telephone, a Session Initiation Protocol (“SIP”) phone, a wireless local loop (“WLL”) station, a personal digital assistant (“PDA”), a handheld device having wireless connection capability, or some other suitable processing device connected to a wireless modem. Accordingly, one or more aspects taught herein can be incorporated into a phone (e.g., a cellular phone or smart phone), a computer (e.g., a laptop), a portable communication device, a headset, a portable computing device (e.g., a personal data assistant), an entertainment device (e.g., a music or video device, or a satellite radio), a gaming device or system, a global positioning system device, or any other suitable device that is configured to communicate via a wireless medium.

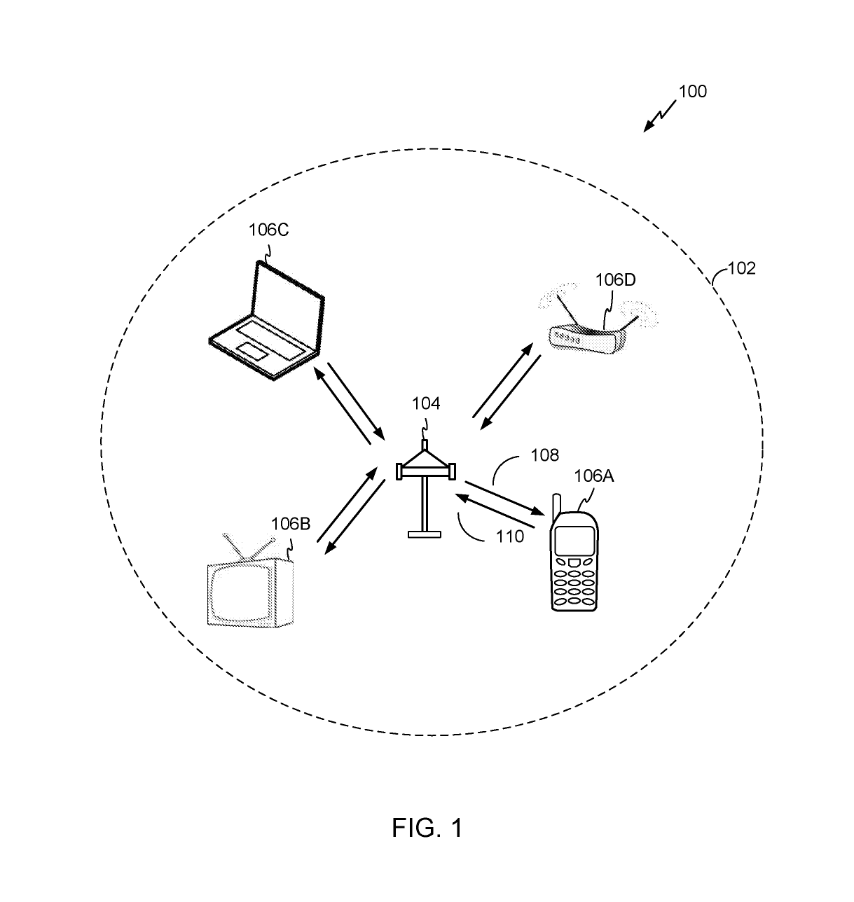

FIG. 1 illustrates an example of a wireless communication system 100 in which aspects of the present disclosure can be employed. The wireless communication system 100 can operate pursuant to a wireless standard, for example the 802.11ax standard. The wireless communication system 100 can include an AP 104, which communicates with STAs 106.

A variety of processes and methods can be used for transmissions in the wireless communication system 100 between the AP 104 and the STAs 106. For example, signals can be transmitted and received between the AP 104 and the STAs 106 in accordance with OFDM/OFDMA techniques. If this is the case, the wireless communication system 100 can be referred to as an OFDM/OFDMA system. Alternatively, signals can be transmitted and received between the AP 104 and the STAs 106 in accordance with CDMA techniques. If this is the case, the wireless communication system 100 can be referred to as a CDMA system.

A communication link that facilitates transmission from the AP 104 to one or more of the STAs 106 can be referred to as a downlink (DL) 108, and a communication link that facilitates transmission from one or more of the STAs 106 to the AP 104 can be referred to as an uplink (UL) 110. Alternatively, a downlink 108 can be referred to as a forward link or a forward channel, and an uplink 110 can be referred to as a reverse link or a reverse channel.

The AP 104 can provide wireless communication coverage in a basic service area (BSA) 102. The AP 104 along with the STAs 106 associated with the AP 104 and that use the AP 104 for communication can be referred to as a basic service set (BSS). It should be noted that the wireless communication system 100 may not have a central AP 104, but rather can function as a peer-to-peer network between the STAs 106. Accordingly, the functions of the AP 104 described herein can alternatively be performed by one or more of the STAs 106.

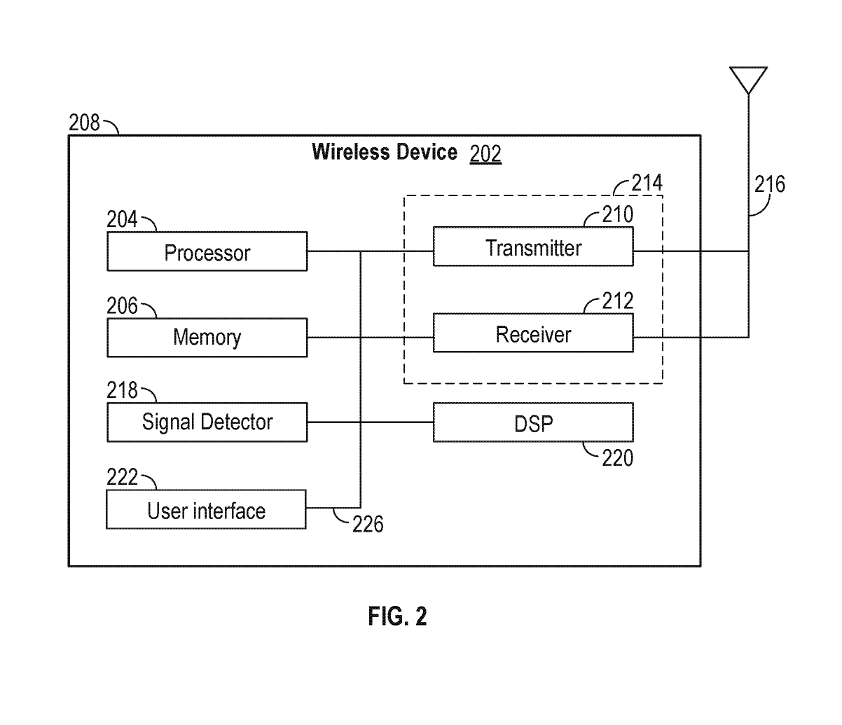

FIG. 2 illustrates various components that can be utilized in a wireless device 202 that can be employed within the wireless communication system 100. The wireless device 202 is an example of a device that can be configured to implement the various methods described herein. For example, the wireless device 202 can comprise the AP 104 or one of the STAs 106.

The wireless device 202 can include a processor 204 which controls operation of the wireless device 202. The processor 204 can also be referred to as a central processing unit (CPU). Memory 206, which can include both read-only memory (ROM) and random access memory (RAM), provides instructions and data to the processor 204. A portion of the memory 206 can also include non-volatile random access memory (NVRAM). The processor 204 typically performs logical and arithmetic operations based on program instructions stored within the memory 206. The instructions in the memory 206 can be executable to implement the methods described herein.

The processor 204 can comprise or be a component of a processing system implemented with one or more processors. The one or more processors can be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system can also include machine-readable media for storing software. Software shall be construed broadly to mean any type of instructions, whether referred to as software, firmware, middleware, microcode, hardware description language, or otherwise. Instructions can include code (e.g., in source code format, binary code format, executable code format, or any other suitable format of code). The instructions, when executed by the one or more processors, cause the processing system to perform the various functions described herein.

The wireless device 202 can also include a housing 208 that can include a transmitter 210 and a receiver 212 to allow transmission and reception of data between the wireless device 202 and a remote location. The transmitter 210 and receiver 212 can be combined into a transceiver 214. An antenna 216 can be attached to the housing 208 and electrically coupled to the transceiver 214. The wireless device 202 can also include (not shown) multiple transmitters, multiple receivers, multiple transceivers, and/or multiple antennas, which can be utilized during MIMO communications, for example.

The wireless device 202 can also include a signal detector 218 that can be used in an effort to detect and quantify the level of signals received by the transceiver 214. The signal detector 218 can detect such signals as total energy, energy per subcarrier per symbol, power spectral density and other signals. The wireless device 202 can also include a digital signal processor (DSP) 220 for use in processing signals. The DSP 220 can be configured to generate a data unit for transmission. In some aspects, the data unit can comprise a physical layer data unit (PPDU). In some aspects, the PPDU is referred to as a packet.

The wireless device 202 can further comprise a user interface 222 in some aspects. The user interface 222 can comprise a keypad, a microphone, a speaker, and/or a display. The user interface 222 can include any element or component that conveys information to a user of the wireless device 202 and/or receives input from the user.

The various components of the wireless device 202 can be coupled together by a bus system 226. The bus system 226 can include a data bus, for example, as well as a power bus, a control signal bus, and a status signal bus in addition to the data bus. Those of skill in the art will appreciate the components of the wireless device 202 can be coupled together or accept or provide inputs to each other using some other mechanism.

Although a number of separate components are illustrated in FIG. 2, those of skill in the art will recognize that one or more of the components can be combined or commonly implemented. For example, the processor 204 can be used to implement not only the functionality described above with respect to the processor 204, but also to implement the functionality described above with respect to the signal detector 218 and/or the DSP 220. Further, each of the components illustrated in FIG. 2 can be implemented using a plurality of separate elements.

As discussed above, the wireless device 202 can comprise an AP 104 or an STA 106, and can be used to transmit and/or receive communications. The communications exchanged between devices in a wireless network can include data units which can comprise packets or frames. In some aspects, the data units can include data frames, control frames, and/or management frames. Data frames can be used for transmitting data from an AP and/or a STA to other APs and/or STAs. Control frames can be used together with data frames for performing various operations and for reliably delivering data (e.g., acknowledging receipt of data, polling of APs, area-clearing operations, channel acquisition, carrier-sensing maintenance functions, etc.). Management frames can be used for various supervisory functions (e.g., for joining and departing from wireless networks, etc.).

Certain aspects of the present disclosure support allowing APs 104 to allocate STAs 106 transmissions in optimized ways to improve efficiency. Both high efficiency wireless (HEW) stations, stations utilizing an 802.11 high efficiency protocol (such as 802.11ax), and stations using older or legacy 802.11 protocols (such as 802.11b), can compete or coordinate with each other in accessing a wireless medium. In some embodiments, the high-efficiency 802.11 protocol described herein can allow for HEW and legacy stations to interoperate according to various OFDMA tone plans (which can also be referred to as tone maps). In some embodiments, HEW stations can access the wireless medium in a more efficient manner, such as by using multiple access techniques in OFDMA. Accordingly, in the case of apartment buildings or densely-populated public spaces, APs and/or STAs that use the high-efficiency 802.11 protocol can experience reduced latency and increased network throughput even as the number of active wireless devices increases, thereby improving user experience.

In some embodiments, APs 104 can transmit on a wireless medium according to various DL tone plans for HEW STAs. For example, with respect to FIG. 1, the STAs 106A-106D can be HEW STAs. In some embodiments, the HEW STAs can communicate using a symbol duration four times that of a legacy STA. Accordingly, each symbol which is transmitted may be four times as long in duration. When using a longer symbol duration, each of the individual tones may only require one-quarter as much bandwidth to be transmitted. For example, in various embodiments, a lx symbol duration can be 3.2 ms and a 4× symbol duration can be 12.8 ms. The AP 104 can transmit messages to the HEW STAs 106A-106D according to one or more tone plans, based on a communication bandwidth. In some aspects, the AP 104 may be configured to transmit to multiple HEW STAs simultaneously, using OFDMA.

### Efficient Tone Plan Design for Multicarrier Allocation

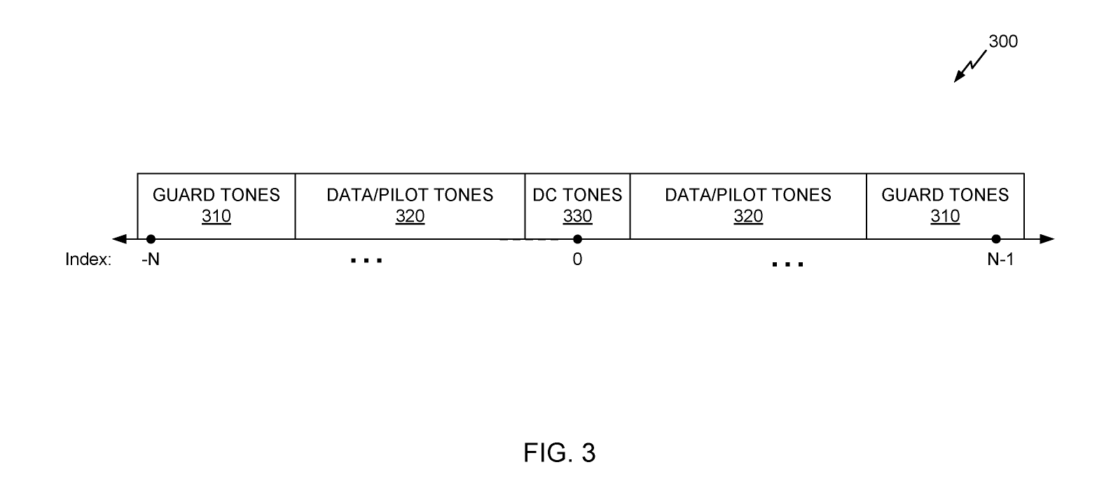

FIG. 3 shows an example 2N-tone plan 300, according to one embodiment. In an embodiment, the tone plan 300 corresponds to OFDM tones, in the frequency domain, generated using a 2N-point FFT. The tone plan 300 includes 2N OFDM tones indexed −N to N−1. The tone plan 300 includes two sets of edge tones 310, two sets of data/pilot tones 320, and a set of direct current (DC) tones 330. In various embodiments, the edge tones 310 and DC tones 330 can be null. In various embodiments, the tone plan 300 includes another suitable number of pilot tones and/or includes pilot tones at other suitable tone locations.

In some aspects, OFDMA tone plans may be provided for transmission using a 4× symbol duration, as compared to various IEEE 802.11 protocols. For example, 4× symbol duration may use a number of symbols which are each 12.8 ms in duration (whereas symbols in certain other IEEE 802.11 protocols may be 3.2 ms in duration).

In some aspects, the data/pilot tones 320 of a transmission 300 may be divided among any number of different users. For example, the data/pilot tones 320 may be divided among between one and eight users. In order to divide the data/pilot tones 320, an AP 104 or another device may signal to the various devices, indicating which devices may transmit or receive on which tones (of the data/pilot tones 320) in a particular transmission. Accordingly, systems and methods for dividing the data/pilot tones 320 may be desired, and this division may be based upon a tone plan.

A tone plan may be chosen based on a number of different characteristics. For example, it may be beneficial to have a simple tone plan, which can be consistent across most or all bandwidths. For example, an OFDMA transmission may be transmitted over 20, 40, or 80 MHz, and it may be desirable to use a tone plan that can be used for any of these bandwidths. Further, a tone plan may be simple in that it uses a smaller number of building block sizes. For example, a tone plan may contain a unit which may be referred to as a tone allocation unit (TAU). This unit may be used to assign a particular amount of bandwidth to a particular user. For example, one user may be assigned bandwidth as a number of TAUs, and the data/pilot tones 320 of a transmission may be broken up into a number of TAUs. In some aspects, it may be beneficial to have a single size of TAU. For example, if there were two or more sizes of TAU, it may require more signaling to inform a device of the tones that are allocated to that device. In contrast, if all tones are broken up into TAUs of consistent size, signaling to a device may simply require telling a device a number of TAUs assigned to that device. Accordingly, using a single TAU size may reduce signaling and simplify tone allocation to various devices.

A tone plan may also be chosen based on efficiency. For example, transmissions of different bandwidths (e.g., 20, 40, or 80 MHz) may have different numbers of tones. Thus, it may be beneficial to choose a TAU size that leaves fewer tones leftover after the creation of the TAUs. For example, if a TAU was 100 tones, and if a certain transmission included 199 tones, this may leave 99 tones leftover after creating one TAU. Thus, 99 tones may be considered “leftover” tones, and this may be quite inefficient. Accordingly, reducing the number of leftover tones may be beneficial. It may also be beneficial if a tone plan is used which allows for the same tone plan to be used in both UL and DL OFDMA transmissions. Further, it may be beneficial if a tone plan is configured to preserve 20 and 40 MHz boundaries, when needed. For example, it may be desirable to have a tone plan which allows each 20 or 40 MHz portion to be decoded separately from each other, rather than having allocations which are on the boundary between two different 20 or 40 MHz portions of the bandwidth. For example, it may be beneficial for interference patterns to be aligned with 20 or 40 MHz channels. Further, it may be beneficial to have channel binding, such that when a 20 MHz transmission and a 40 MHz transmission are transmitted, to create a 20 MHz “hole” in the transmission when transmitted over 80 MHz. This may allow, for example, a legacy packet to be transmitted in this unused portion of the bandwidth. Finally, it may also be advantageous to use a tone plan which provides for fixed pilot tone locations in various different transmissions, such as in different bandwidths.

Generally, a number of different implementations are presented. For example, certain implementations have been made which include multiple different building blocks, such as two or more different tone units. For example, there may be a basic tone unit (BTU), and a small tone unit (STU), which is smaller than the basic tone unit. Further, the size of the BTU itself may vary based upon the bandwidth of the transmission. In another implementation, resource blocks are used, rather than tone units. However, in some aspects, it may be beneficial to use a single tone allocation unit TAU for all bandwidths of transmissions in OFDMA.

### Interleaver Parameters Without Walking Pilots

In various embodiments, an 80 MHz single-user (SU) tone plan can include any of the usable tones, DC tones, data tones, modulation and coding scheme (MCS) exclusions, and pilot tones shown below in Table 1. Although Table 1 assumes 23 guard tones, different numbers of guard tones can be used. MCS validity is defined in the IEEE 802.11ac specification. Generally, the rule for determining whether an MCS is valid is that the number of coded bits per subcarrier must be an integer multiple of the number of encoding streams. Further, the number of coded bits per encoding stream must be an integer multiple of the denominator in the code rate. Accordingly, certain MCS and spatial stream combinations may be invalid when these conditions are not met. Thus, for each potential data tones (Ndata) value discussed below, a number of exclusions are provided, in some cases with the listing of the various exclusions. In some aspects, it may be beneficial to select a value of Ndata that has a minimum number of exclusions.

TABLE 1

| | | | MCS | |
|---|---|---|---|---|
| Usable Tones | DC Tones | Data Tones | Exclusions | Pilot Tones |
| 998 | 3 | 990 | 5 | 8 |
| 998 | 3 | 984 | 5 | 14 |
| 998 | 3 | 982 | 18 | 16 |
| 996 | 5 | 988 | 14 | 8 |
| 996 | 5 | 984 | 5 | 12 |
| 996 | 5 | 980 | 11 | 16 |
| 994 | 7 | 986 | 18 | 8 |
| 994 | 7 | 978 | 10 | 16 |

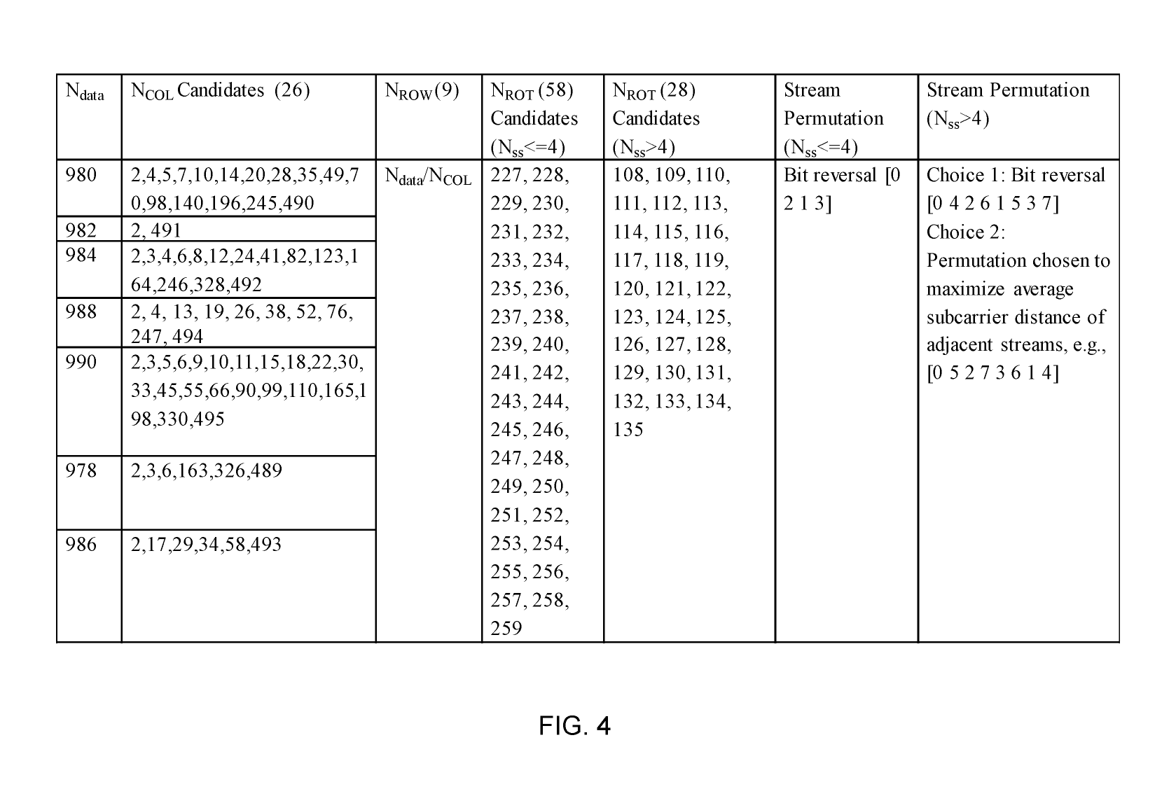

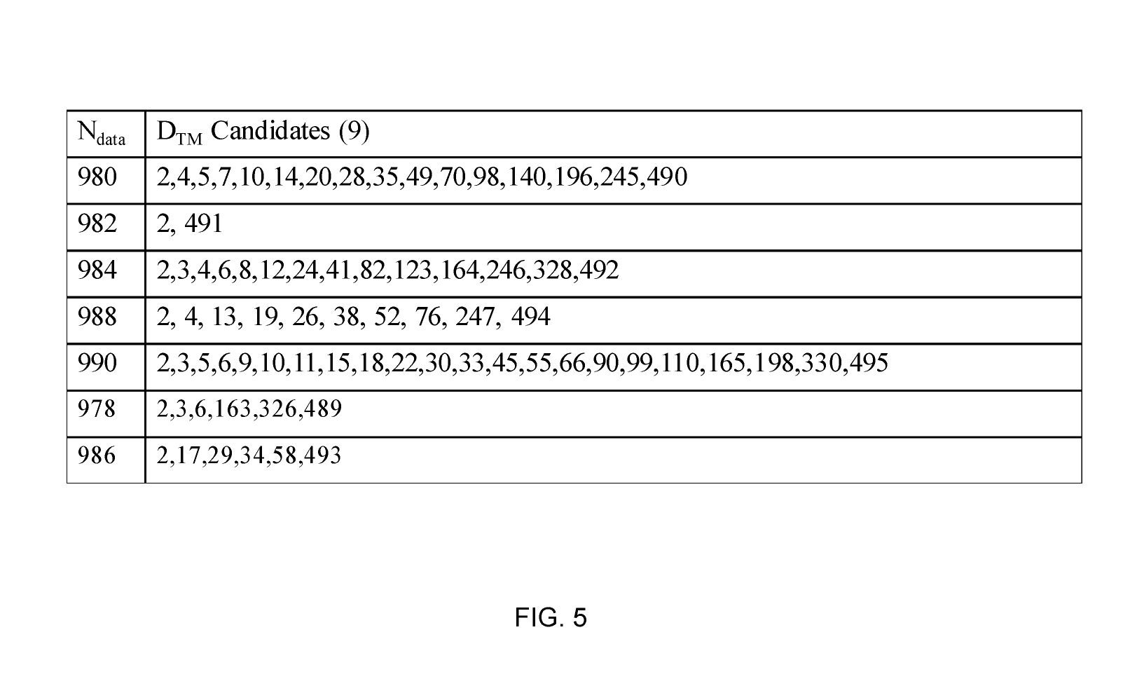

In various embodiments, the AP 104 can allocate tones of the 80 MHz SU tone plan to STAs 106 in multiples of 242- and/or 26-tone allocation units. For example, in some embodiments, four 242-tone blocks (4×242) can be allocated. In n×242 embodiments (that is, 1×242, 2×242, 4×242, etc.), the AP 104 can perform two-step interleaving including a first step of frequency segment parsing, followed by a second step of 234-tone interleaving within each 242-tone block (assuming 8 pilot tones). In some embodiments, four 242-tone blocks can be allocated in addition to one 26-tone block (4×242+26). In such embodiments, the AP 104 can perform two-step interleaving including a first step of frequency segment parsing, followed by a second step of 234-tone interleaving within each 242-tone block (assuming 8 pilot tones) and 24-tone interleaving within the 26-tone block (assuming 2 pilot tones). In the embodiments shown above in Table 1 (for example, 996 or 998 total tones), new interleaver parameters can be use according to FIGS. 4 and 5, discussed below.

FIG. 4 is a chart illustrating candidate interleaver parameters for different numbers of data tones, according to a 994-, 996-, or 998-tone plan embodiment. In a particular embodiment, the interleaver depth (e.g., the number of columns (Ncol)) can be a factor of the number of data tones (Ndata). In various embodiments, a 978 data tone block can have an interleaver depth of 2, 3, 6, 163, 326, or 489. In various embodiments, a 980 data tone block can have an interleaver depth of 2, 4, 5, 7, 10, 14, 20, 28, 35, 49, 70, 98, 140, 196, 245, or 290. In various embodiments, a 982 data tone block can have an interleaver depth of 2 or 491. In various embodiments, a 984 data tone block can have an interleaver depth of 2, 3, 4, 6, 8, 12, 24, 41, 82, 123, 164, 246, 328, or 492. In various embodiments, a 986 data tone block can have an interleaver depth of 2, 17, 29, 34, 58, or 493. In various embodiments, a 988 data tone block can have an interleaver depth of 2, 4, 13, 19, 26, 38, 52, 76, 247, or 494. In various embodiments, a 990 data tone block can have an interleaver depth of 2, 3, 5, 6, 9, 10, 11, 15, 18, 22, 30, 33, 45, 55, 66, 90, 99, 110, 165, 198, 330 or 495.

The number of rows (Nrow) can be a function of the number of columns (Ncol) and the number of data tones (Ndata). For example, the number of rows (Nrow) can be equal to the number of data tones (Ndata) divided by the interleaving depth (Ncol) (e.g., Nrow=Ndata/Ncol).

A frequency rotation can be applied to the spatial streams if there is more than one spatial stream. The frequency rotation can be based on a base subcarrier rotation (NROT) and a rotation index. The base subcarrier rotation (NROT) and the rotation index can be based on the number of data tones (Ndata) and the number of spatial streams (Nss).

For example, if the data tone block has 4 or less spatial streams (Nss), the base subcarrier rotation (NROT) can be any of 227-269. The rotation index (e.g., the 6th column) can be a bit reversal of [0 2 1 3] in this scenario. Alternatively, if the data tone block has more than 4 spatial streams (Nss), the base subcarrier rotation (NROT) can be any of 108-135. The rotation index (e.g., the 7th column) can be a bit reversal of [0 4 2 6 1 5 3 7] in some embodiments, or the rotation index can be chosen to maximize (or increase) an average subcarrier distance of adjacent streams in other embodiments (e.g., [0 5 2 7 3 6 1 4]). Although a rotation index of [0 5 2 7 3 6 1 4] is used herein as one example of an index maximizing average subcarrier distance, any other rotation indexes that maximizes (or increases) average subcarrier distance can be used. For example, any permutation which maximizes the average subcarrier distance of adjacent streams may be used, and [0 5 2 7 3 6 1 4] is only one example.

FIG. 5 is a chart illustrating a low density parity check (LDPC) tone mapping distance (D_{TM}) for different numbers of data tones (N_{data}). The mapping distance (D_{TM}) can be at least as large as the number of coded bits per OFDM symbol (N_{CRPS}) divided by the LDPC codeword length (L_{CW}) (e.g., N_{CBPS}/ L_{CW}≦D_{TM}). Additionally, the mapping distance (D_{TM}) can be an integer divisor of the number of subcarriers (N_{SD}). The mapping distance (D_{TM}) can be constant over rates within each bandwidth to enable a tone de-mapper implemented at a Fast Fourier Transform (FFT) module of the receive circuits 216a-216c with fixed tone processing.

In various embodiments, the 978 data tone block can have a mapping distance (D_{TM}) of 2, 17, 29, 34, 58, or 493. The 980 data tone block can have a D_{TM} of 2, 4, 5, 7, 10, 14, 20, 28, 35, 49, 70, 98, 140, 196, 145, or 490. The 982 data tone block can have a D_{TM} of 2 or 491. The 984 data tone block can have a D_{TM} of 2, 3, 4, 6, 8, 12, 24, 41, 82, 123, 164, 246, 328, or 492. The 986 data tone block can have a D_{TM} of 2, 17, 29, 34, 58, or 493. The 988 data tone block can have a D_{TM} of 2, 4, 13, 19, 26, 38, 52, 76, 247, or 494. The 990 data tone block can have a D_{TM} of 2, 3, 5, 6, 9, 10, 11, 15, 18, 22, 30, 33, 45, 55, 66, 90, 99, 110, 165, 198, 330 or 495.

### Walking Pilots

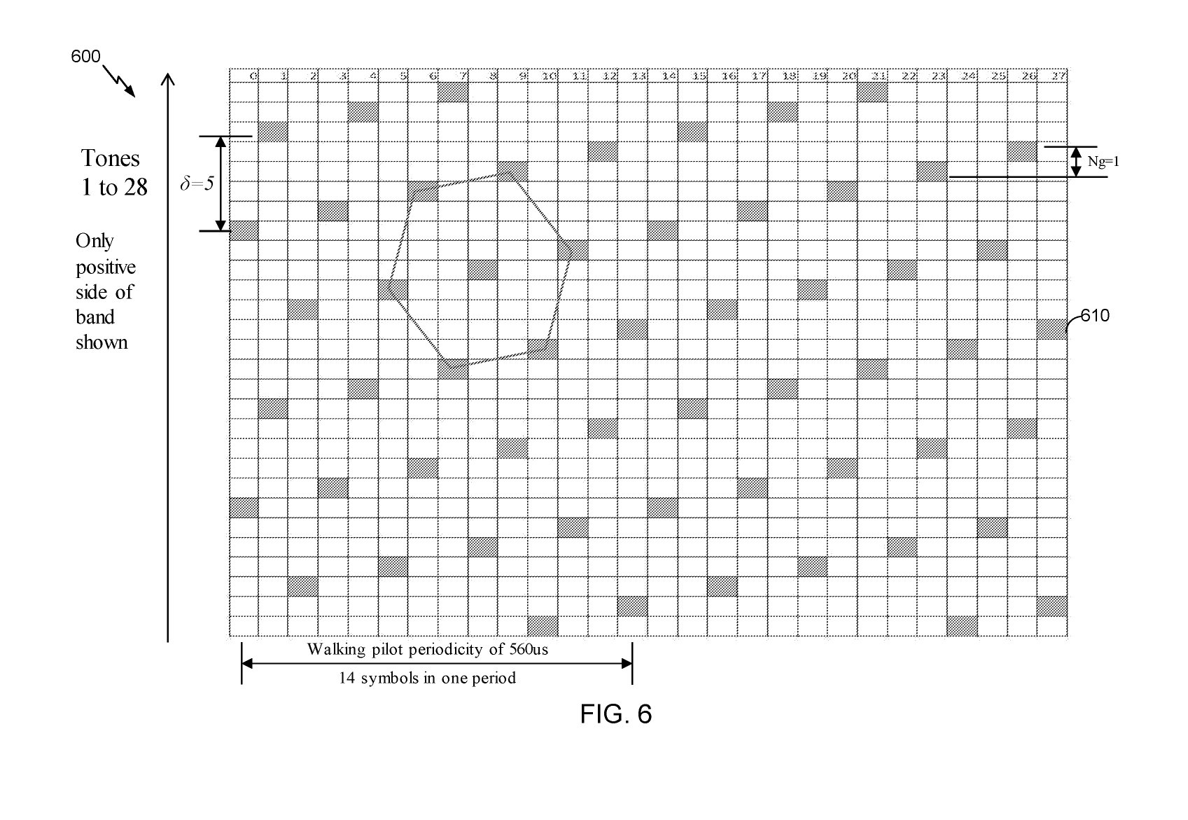

In various embodiments, the 80 MHz SU tone plan can accommodate walking pilots. Walking pilots are defined in the IEEE 802.11ah specification. Generally, a “walking pilot” arrangement may be employed wherein the pilot signal changes or varies in the frequency domain. The pilot signal can appear at different points in different transmitted frames in an irregular sequence, i.e., a non-sequential order. An example of walking pilot tones is shown in FIG. 6.

FIG. 6 is a diagram 600 illustrating various walking pilot parameters. On the x-axis a plurality of symbols is shown, numbered 0-27. On the y-axis, a plurality of tones is shown, numbered 1-28. In the illustration of FIG. 6, only positive tones are shown, although the frequency band can include additional tones. A plurality of walking pilot tones 610 are shown as shaded boxes. In general, walking pilot tone parameters can be defined by an offset, a periodicity, and a channel interpolation factor Ng. In the illustrated embodiment, the walking pilots 610 have a 14-symbol periodicity equating to 560 μs. The periodicity, or channel update interval, defines the number of symbols or time periods between each walking pilot 610 on a given tone. In an embodiment, periodicity can be determined by mobility speed.

In the illustrated embodiment, the channel interpolation factor Ng is 1. The channel interpolation factor Ng can define the number of periods over which all tones are visited by walking pilots 610. Similarly, in the illustrated embodiment, the offset δ is 5. The offset δ can define a number of tones over which each walking pilot 610 varies between symbols. In the illustrated embodiment, the offset δ of 5 achieves the shortest walking period of 14 and evenly distributes pilots in the time-frequency grid 600.

In some embodiments, the receiver, due primarily to Doppler effects but also due to other environmental conditions, may have difficulty determining the frame contents and the position of the pilot in the frame. Tracking of phase and amplitude, or in other words, the ability to obtain accurate phase and amplitude values at the receiver, is highly desirable. In some embodiments, updating channels frequently (e.g., every 6-7 symbols) can impose a very large overhead. For example, in embodiments where Ng=2, pilots can take up 7% of tones. In some embodiments, a midamble can have similar overhead to walking pilots. Accordingly, it can be challenging to achieve high Doppler tolerance while reducing overhead.

In some embodiments, the 80 MHz tone plan can include 32-34 pilot tones in order to provide comparable Doppler performance to 20 and 40 MHz tone plans. In other embodiments, the 80 MHz tone plan can include 16 or fewer pilot tones, which can be non-walking pilot tones. Thus, 20 and 40 MHz tone plans can be used in high Doppler applications.

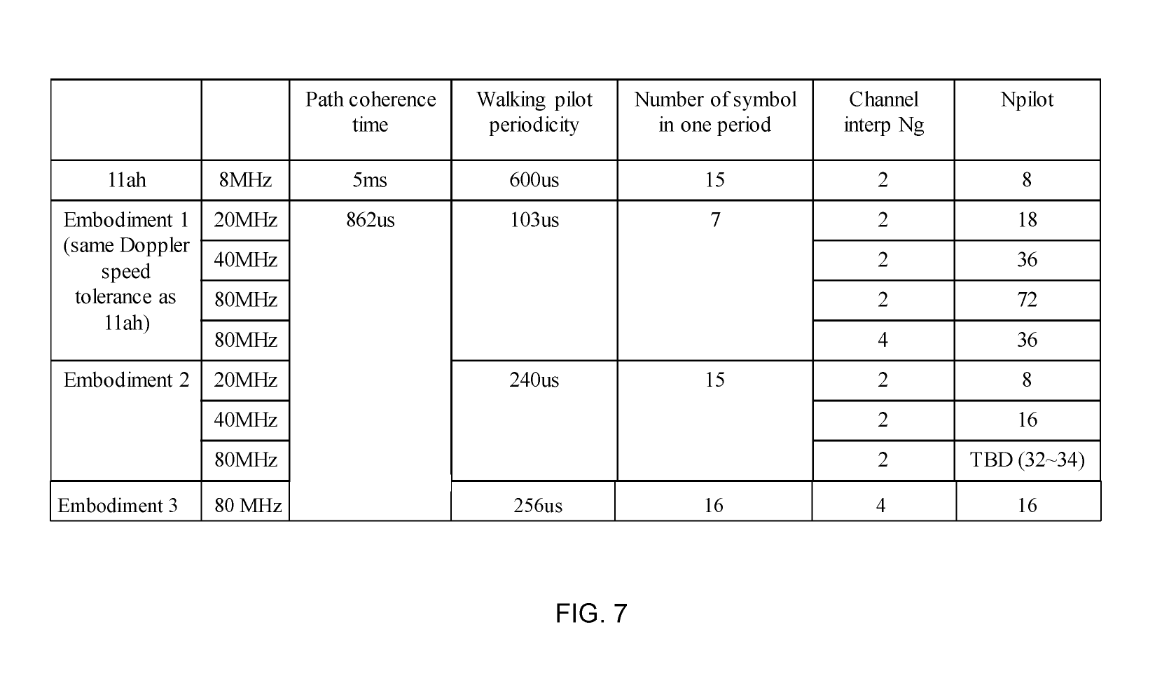

In various embodiments, walking pilot transmission power can be boosted (for example, by 3 dB, 6 dB, etc.). Accordingly, a relatively higher channel interpolation factor can be used with relatively fewer tones used for walking pilots, as compared to an un-boosted embodiment. For example, in an embodiment, the 80 MHz tone plan can include 16 or fewer walking pilot tones (for example, 16 tones). The channel interpolation factor can be 4 or more (for example, 4). The pilot tones can be boosted (for example, by 3 dB or 6 dB). Various walking pilot parameters are discussed below with respect to FIG. 7.

FIG. 7 is a chart illustrating walking pilot parameters according to various embodiments. As shown, 802.11ah includes an 80 MHz tone plan having a 5 ms path coherence time, 600 μs walking pilot periodicity, 15 symbols per period, a channel interpolation factor Ng of 2, and 8 walking pilots.

Another embodiment (1) includes 20, 40, and two 80 MHz tone plans having an 862 μs path coherence time, 103 μs walking pilot periodicity, and 7 symbols per period. The 20, 40, and first 80 MHz tone plans have a channel interpolation factor Ng of 2, whereas the second 80 MHz tone plan has a channel interpolation factor Ng of 4. The 20, 40, first 80, and second 80 MHz tone plans have 18, 36, 72, and 36 walking pilots, respectively.

Another embodiment (2) includes 20, 40, and 80 MHz tone plans having an 862 μs path coherence time, 240 μs walking pilot periodicity, 15 symbols per period, and a channel interpolation factor Ng of 2. The 20, 40, and 80 MHz tone plans have 8, 16, and around 32 to around 34 walking pilots, respectively.

Another embodiment (3) includes an 80 MHz tone plan having an 862 μs path coherence time, 256 μs walking pilot periodicity, 16 symbols per period, and a channel interpolation factor Ng of 4. The 80 MHz tone plans has 16 walking pilots. In the illustrated embodiment (3), the pilot tones can be boosted (for example, by 3 dB or 6 dB). Although various parameters are shown in FIG. 7 as being associated with a particular embodiment, any combination of parameters from the illustrated embodiments are contemplated herein. For example, the 80 MHz tone plan of embodiment (3) can be included in embodiment (2), and so on.

### Interleaver Parameters Supporting Walking Pilots

In various embodiments, an 80 MHz single-user (SU) tone plan supporting walking pilots can include any of the usable tones, DC tones, data tones, modulation and coding scheme (MCS) exclusions, and pilot tones shown below in Table 2. Although Table 2 assumes 23 guard tones, different numbers of guard tones can be used. MCS validity is defined in the IEEE 802.11ac specification. Generally, the rule for determining whether an MCS is valid is that the number of coded bits per subcarrier must be an integer multiple of the number of encoding streams. Further, the number of coded bits per encoding stream must be an integer multiple of the denominator in the code rate. Accordingly, certain MCS and spatial stream combinations may be invalid when these conditions are not met. Thus, for each potential data tones (Ndata) value discussed below, a number of exclusions are provided, in some cases with the listing of the various exclusions. In some aspects, it may be beneficial to select a value of Ndata that has a minimum number of exclusions.

TABLE 2

| | | | MCS | |
|---|---|---|---|---|
| Usable Tones | DC Tones | Data Tones | Exclusions | Pilot Tones |
| 996 | 5 | 964 | 14 | 32 |
| 996 | 5 | 962 | 18 | 34 |
| 998 | 3 | 966 | 11 | 32 |
| 998 | 3 | 964 | 14 | 34 |
| 994 | 7 | 962 | 18 | 32 |
| 994 | 7 | 960 | 3 | 34 |

| | | |
|---|---|---|
| 994 | 7 | Frequency segment parsing + 234/26 |
| | | tone interleaving |

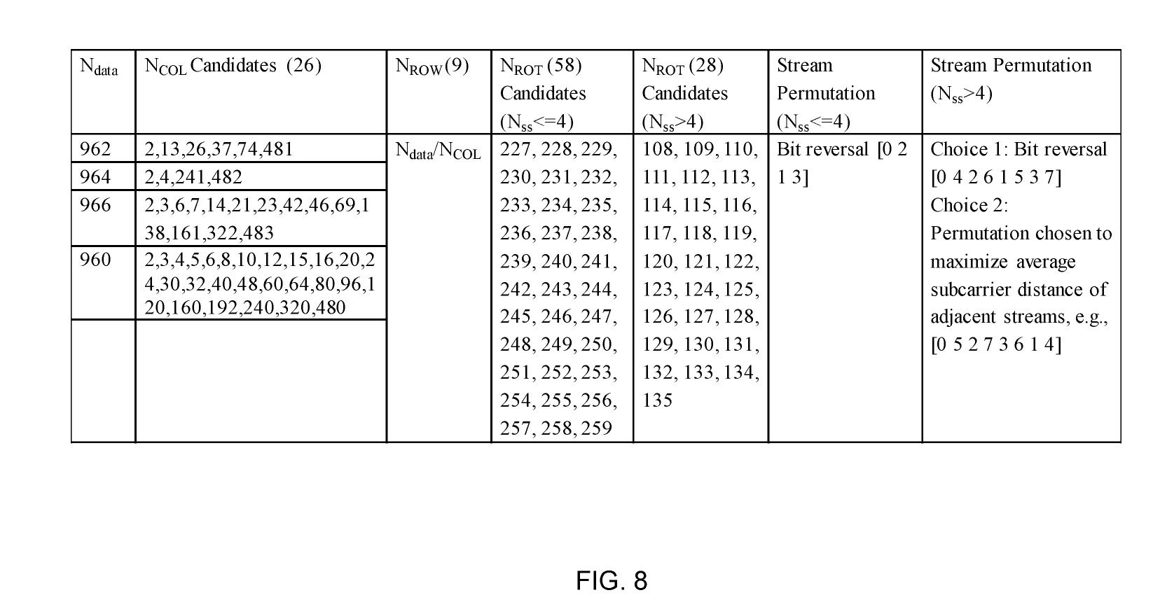

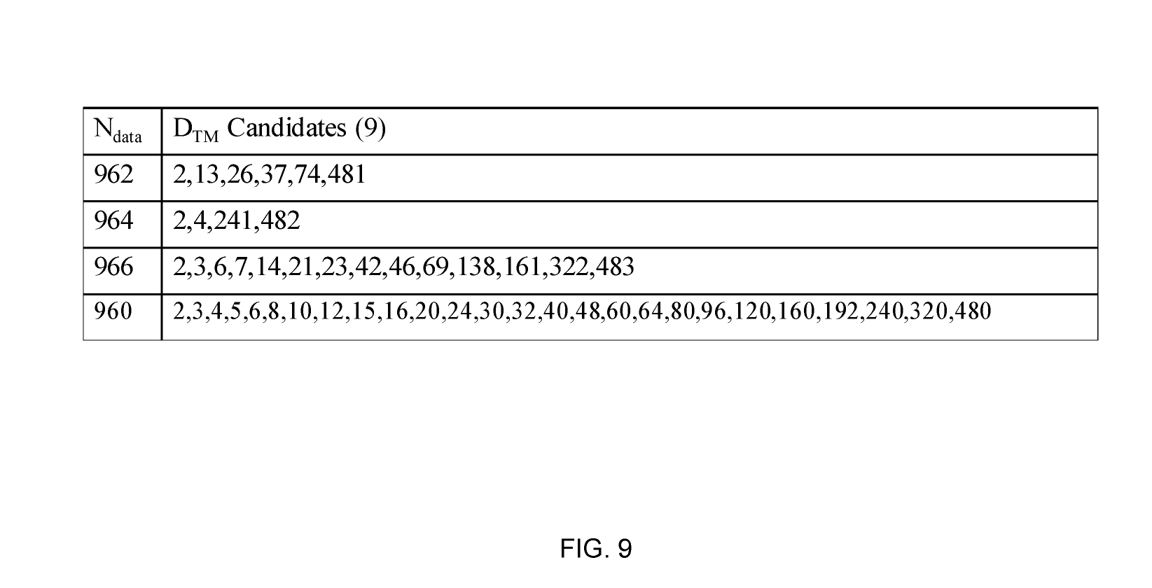

As discussed above, in various embodiments, the AP 104 can allocate tones of the 80 MHz SU tone plan to STAs 106 in multiples of 242- and/or 26-tone allocation units. The AP 104 can perform two-step interleaving including a first step of frequency segment parsing, followed by a second step of 234-tone interleaving within each 242-tone block (assuming 8 pilot tones) and 24-tone interleaving within the 26-tone block (assuming 2 pilot tones). In the embodiments shown above in Table 2 (for example, 996 or 998 total tones), new interleaver parameters can be use according to FIGS. 8 and 9, discussed below.

FIG. 8 is a chart illustrating candidate interleaver parameters for different numbers of data tones, according to a 960-, 962-, 964-, or 966-tone plan embodiment. In a particular embodiment, the interleaver depth (e.g., the number of columns (Ncol)) can be a factor of the number of data tones (Ndata). In various embodiments, a 960 data tone block can have an interleaver depth of 2, 3, 4, 6, 8, 10, 12, 15, 16, 20, 24, 30, 32, 40, 48, 60, 64, 80, 96, 120, 160, 192, 240, 320, or 480. In various embodiments, a 962 data tone block can have an interleaver depth of 2, 13, 26, 37, 74, or 481. In various embodiments, a 964 data tone block can have an interleaver depth of 2, 4, 241, or 482. In various embodiments, a 966 data tone block can have an interleaver depth of 2, 3, 6, 7, 14, 21, 23, 42, 46, 69, 138, 161, 322, or 483.

The number of rows (Nrow) can be a function of the number of columns (Ncol) and the number of data tones (Ndata). For example, the number of rows (Nrow) can be equal to the number of data tones (Ndata) divided by the interleaving depth (Ncol) (e.g., Nrow=Ndata/Ncol).

A frequency rotation can be applied to the spatial streams if there is more than one spatial stream. The frequency rotation can be based on a base subcarrier rotation (NROT) and a rotation index. The base subcarrier rotation (NROT) and the rotation index can be based on the number of data tones (Ndata) and the number of spatial streams (Nss).

For example, if the data tone block has 4 or less spatial streams (Nss), the base subcarrier rotation (NROT) can be any of 227-259. The rotation index (e.g., the 6th column) can be a bit reversal of [0 2 1 3] in this scenario. Alternatively, if the data tone block has more than 4 spatial streams (Nss), the base subcarrier rotation (NROT) can be any of 108-135. The rotation index (e.g., the 7th column) can be a bit reversal of [0 4 2 6 1 5 3 7] in some embodiments, or the rotation index can be chosen to maximize (or increase) an average subcarrier distance of adjacent streams in other embodiments (e.g., [0 5 2 7 3 6 1 4]). Although a rotation index of [0 5 2 7 3 6 1 4] is used herein as one example of an index maximizing average subcarrier distance, any other rotation indexes that maximizes (or increases) average subcarrier distance can be used. For example, any permutation which maximizes the average subcarrier distance of adjacent streams may be used, and [0 5 2 7 3 6 1 4] is only one example.

FIG. 9 is a chart illustrating a low density parity check (LDPC) tone mapping distance (D_{TM}) for different numbers of data tones (N_{data}). The mapping distance (D_{TM}) can be at least as large as the number of coded bits per OFDM symbol (N_{CBPS}) divided by the LDPC codeword length (L_{CW}) (e.g., N_{CBPS}/L_{CW}≦D_{TM}). Additionally, the mapping distance (D_{TM}) can be an integer divisor of the number of subcarriers (N_{SD}). The mapping distance (D_{TM}) can be constant over rates within each bandwidth to enable a tone de-mapper implemented at a Fast Fourier Transform (FFT) module of the receive circuits 216a-216c with fixed tone processing.

In various embodiments, the 960 data tone block can have a mapping distance (D_{TM}) of 2, 3, 4, 6, 8, 10, 12, 15, 16, 20, 24, 30, 32, 40, 48, 60, 64, 80, 96, 120, 160, 192, 240, 320, or 480. The 962 data tone block can have a D_{TM} of 2, 13, 26, 37, 74, or 481. The 964 data tone block can have a D_{TM} of 2, 4, 241, or 482. The 966 data tone block can have a D_{TM} of 2, 3, 6, 7, 14, 21, 23, 42, 46, 69, 138, 161, 322, or 483.

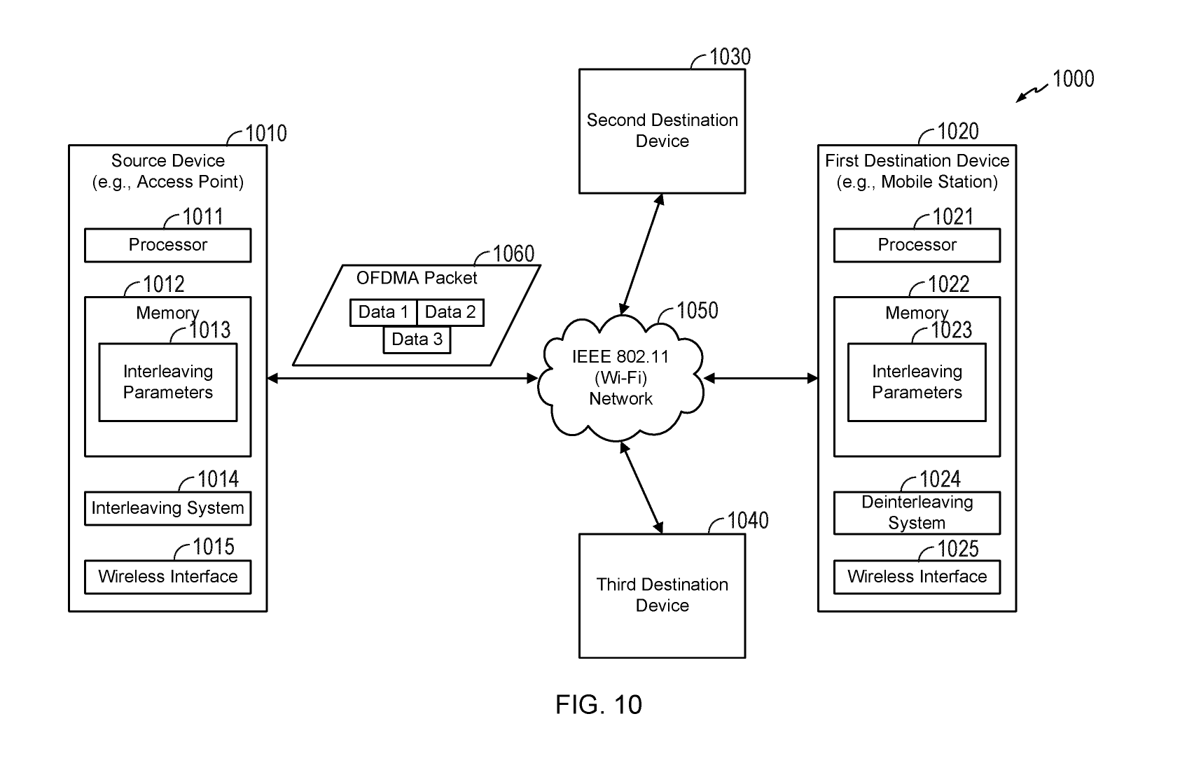

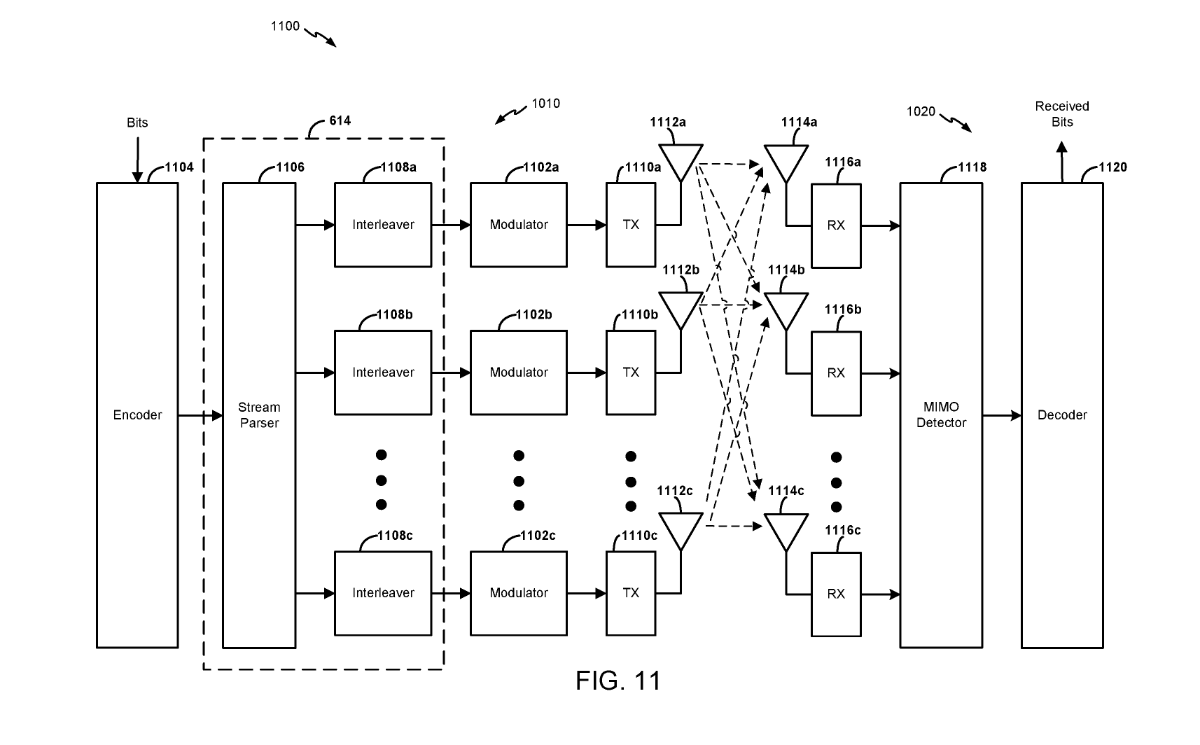

In various embodiments, the interleaving parameters discussed above (for example, with respect to FIGS. 4, 5, 8, and 9) can be implemented by the systems 1000 and 1100 of FIGS. 10 and 11, discussed below.

FIG. 10 shows a system 1000 that is operable to generate interleaving parameters for orthogonal frequency-division multiple access (OFDMA) tone plans, according to an embodiment. The system 1000 includes a first device (e.g., a source device) 1010 configured to wirelessly communicate with a plurality of other devices (e.g., destination devices) 1020, 1030, and 1040 via a wireless network 1050. In alternate embodiments, a different number of source devices destination devices can be present in the system 1000. In various embodiments, the source device 1010 can include the AP 104 (FIG. 1) and the other devices 1020, 1030, and 1040 can include STAs 106 (FIG. 1). The system 1000 can include the system 100 (FIG. 1). In various embodiments, any of the devices 1010, 1020, 1030, and 1040 can include the wireless device 202 (FIG. 2).

In a particular embodiment, the wireless network 1050 is an Institute of Electrical and Electronics Engineers (IEEE) 802.11 wireless network (e.g., a Wi-Fi network). For example, the wireless network 61050 can operate in accordance with an IEEE 802.11 standard. In a particular embodiment, the wireless network 1050 supports multiple access communication. For example, the wireless network 1050 can support communication of a single packet 1060 to each of the destination devices 1020, 1030, and 1040, where the single packet 1060 includes individual data portions directed to each of the destination devices. In one example, the packet 1060 can be an OFDMA packet, as further described herein.

The source device 1010 can be an access point (AP) or other device configured to generate and transmit multiple access packet(s) to multiple destination devices. In a particular embodiment, the source device 1010 includes a processor 1011 (e.g., a central processing unit (CPU), a digital signal processor (DSP), a network processing unit (NPU), etc.), a memory 1012 (e.g., a random access memory (RAM), a read-only memory (ROM), etc.), and a wireless interface 1015 configured to send and receive data via the wireless network 1050. The memory 1012 can store binary convolutional code (BCC) interleaving parameters 1013 used by an interleaving system 1014 to interleave data according to the techniques described with respect to an interleaving system 1014 of FIG. 11.

As used herein, a “tone” can represent a frequency or set of frequencies (e.g., a frequency range) within which data can be communicated. A tone can alternately be referred to as a subcarrier. A “tone” can thus be a frequency domain unit, and a packet can span multiple tones. In contrast to tones, a “symbol” can be a time domain unit, and a packet can span (e.g., include) multiple symbols, each symbol having a particular duration. A wireless packet can thus be visualized as a two-dimensional structure that spans a frequency range (e.g., tones) and a time period (e.g., symbols).

As an example, a wireless device can receive a packet via an 80 megahertz (MHz) wireless channel (e.g., a channel having 80 MHz bandwidth). The wireless device can perform a 512-point fast Fourier transform (FFT) to determine 512 tones in the packet. A subset of the tones can be considered “useable” and the remaining tones can be considered “unusable” (e.g., can be guard tones, direct current (DC) tones, etc.). To illustrate, 496 of the 512 tones can be useable, including 474 data tones and 22 pilot tones. As another example, there can be 476 data tones and 20 pilot tones. It should be noted that the aforementioned channel bandwidths, transforms, and tone plans are just examples. In alternate embodiments, different channel bandwidths (e.g., 5 MHz, 6 MHz, 6.5 MHz, 40 MHz, 80 MHz, etc.), different transforms (e.g., 256-point FFT, 1024-point FFT, etc.), and/or different tone plans can be used.

In a particular embodiment, a packet can include different block sizes (e.g., a different number of data tones per sub-band) that are transmitted over one or more spatial streams. For example, the packet can include 12 data tones per sub-band, 36 data tones per sub-band, 72 data tones per sub-band, 120 data tones per sub-band, 156 data tones per sub-band, or 312 data tones per sub-band. Interleave depths, interleave rotation indexes, and base subcarrier rotations combinations can be provided for each block size.

In a particular embodiment, the interleaving parameters 1013 can be used by the interleaving system 1014 during generation of the multiple access packet 1060 to determine which data tones of the packet 1060 are assigned to individual destination devices. For example, the packet 1060 can include distinct sets of tones allocated to each individual destination device 1020, 1030, and 1040. To illustrate, the packet 1060 can utilize interleaved tone allocation.

The destination devices 1020, 1030, and 1040 can each include a processor (e.g., a processor 1021), a memory (e.g., a memory 1022), and a wireless interface (e.g., a wireless interface 1025). The destination devices 1020, 1030, and 1040 can also each include a deinterleaving system 1024 configured to deinterleave packets (e.g., single access packets or multiple access packets), as described with reference to a MIMO detector 1118 of FIG. 11. In one example, the memory 1022 can store interleaving parameters 1023 identical to the interleaving parameters 1013.

During operation, the source device 1010 can generate and transmit the packet 1060 to each of the destination devices 1020, 1030, and 1040 via the wireless network 1050. The packet 1060 can include distinct sets of data tones that are allocated to each individual destination device according to an interleaved pattern.

The system 1000 of FIG. 10 can thus provide OFDMA data tone interleaving parameters for use by source devices and destination devices to communicate over an IEEE 802.11 wireless network. For example, the interleaving parameters 1013, 1023 (or portions thereof) can be stored in a memory of the source and destination devices, as shown, can be standardized by a wireless standard (e.g., an IEEE 802.11 standard), etc. It should be noted that various data tone plans described herein can be applicable for both downlink (DL) as well as uplink (UL) OFDMA communication.

For example, the source device 1010 (e.g., an access point) can receive signal(s) via the wireless network 1050. The signal(s) can correspond to an uplink packet. In the packet, distinct sets of tones can be allocated to, and carry uplink data transmitted by, each of the destination devices (e.g., mobile stations) 1020, 1030, and 1040.

FIG. 11 shows an exemplary multiple-input-multiple-output (MIMO) system 1100 that can be implemented in wireless devices, such as the wireless device of FIG. 10, to transmit and receive wireless communications. The system 1100 includes the first device 1010 of FIG. 10 and the destination device 1020 of FIG. 10.

The first device 1010 includes an encoder 1104, the interleaving system 1014, a plurality of modulators 1102a-1102c, a plurality of transmission (TX) circuits 1110a-1110c, and a plurality of antennas 1112a-1112c. The destination device 1020 includes a plurality of antennas 1114a-1114c, a plurality of receive (RX) circuits 1116a-1116c, a MIMO detector 1118, and a decoder 1120.

A bit sequence can be provided to the encoder 1104. The encoder 1104 can be configured to encode the bit sequence. For example, the encoder 1104 can be configured to apply a forward error correcting (FEC) code to the bit sequence. The FEC code can be a block code, a convolutional code (e.g., a binary convolutional code), etc. The encoded bit sequence can be provided to the interleaving system 1014.

The interleaving system 1014 can include a stream parser 1106 and a plurality of spatial stream interleavers 1108a-1108c. The stream parser 1106 can be configured to parse the encoded bit stream from the encoder 1104 to the plurality of spatial stream interleavers 1108a-1108c.

Each interleaver 1108a-1108c can be configured to perform frequency interleaving. For example, the stream parser 1106 can output blocks of coded bits per symbol for each spatial stream. Each block can be interleaved by a corresponding interleaver 1108a-1108c that writes to rows and reads out columns. The number of columns (Ncol), or the interleaver depth, can be based on the number of data tones (Ndata). The number of rows (Nrow) can be a function of the number of columns (Ncol) and the number of data tones (Ndata). For example, the number of rows (Nrow) can be equal to the number of data tones (Ndata) divided by the interleaving depth (Ncol) (e.g., Nrow=Ndata /Ncol).

Referring back to FIG. 11, the outputs of each interleaver 1108a-1108c (e.g., transmit streams) can be provided to the corresponding modulator 1102a-1102c. Each modulator 1102a-1102c can be configured to modulate the corresponding transmit stream and pass the modulated transmit stream to the corresponding transmission circuit 1110a-1110c. In a particular embodiment, the bits (e.g., the transmit streams) can be modulated using Quadrature Phase Shift Keying (QPSK) modulation, Binary Phase Shift Keying (BPSK) modulation, or Quadrature Amplitude Modulation (QAM) (e.g., 16-QAM, 64-QAM, 256-QAM). The transmission circuits 1110a-1110c can be configure to transmit the modulated transmit streams over a wireless network (e.g., an IEEE 802.11 wireless network) via the corresponding antennas 1112a-1112c.

In a particular embodiment, the antennas 1112a-1112c are distinct and spatially separated antennas. In another embodiment, distinct signal can be combined into different polarizations and transmitted via a subset of the antennas 1112-1112c. For example, the distinct signals can be combined where spatial rotation or spatial spreading is performed and multiple spatial streams are mapped to a single antenna.

The receive circuits 1116a-1116c of the destination device 1029 can receive the interleaved encoded bits via the corresponding antennas 1114a-1114c. The outputs of the receive circuits 1116a-1116c are provided to the MIMO detector 1118, and the output of the MIMO detector 1118 is provided to the decoder 1120. In a particular embodiment, the MIMO detector 1118 can include a deinterleaving system configured to perform reverse operations of the interleaving system 1014. The decoder 1120 can output received bits which, without unrecoverable errors, are the same as the transmitted bits provided to the encoder 1104.

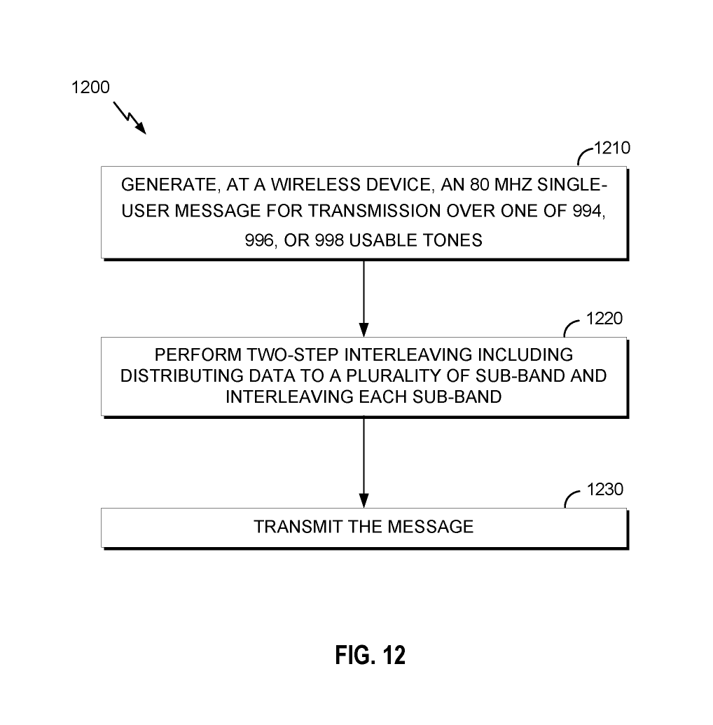

FIG. 12 shows a flowchart 1200 of an exemplary method of wireless communication that can be employed within the wireless communication system 100 of FIG. 1. The method can be implemented in whole or in part by the devices described herein, such as the AP 104 (FIG. 1), any of the STAs 106 (FIG. 1), the wireless device 202 shown in FIG. 2, the devices 1010, 1020, 1030, or 1040 (FIG. 10). Although the illustrated method is described herein with reference to the wireless communication system 100 discussed above with respect to FIG. 1, the wireless device 202 discussed above with respect to FIG. 2, the system 1000 of FIG. 5, a person having ordinary skill in the art will appreciate that the illustrated method can be implemented by another device described herein, or any other suitable device. Although the illustrated method is described herein with reference to a particular order, in various embodiments, blocks herein can be performed in a different order, or omitted, and additional blocks can be added.

First, at block 1210, a wireless device generates an 80 MHz single-user message for transmission over one of 994, 996, or 998 usable tones. For example, the AP 104 can generate the message according to the 80 MHz SU tone plan discussed above with respect to Tables 1 and 2.

Next, at block 1220, the wireless device performs two-step interleaving. Performing two-step interleaving includes distributing data to a plurality of sub-bands and interleaving each sub-band. For example, the AP 104 can interleave the message according to the parameters shown and discussed above with respect to FIGS. 4, 5, 8, and/or 9.

In various embodiments, interleaving each sub-band can further include one or more of: using an interleaver depth of 2, 3, 6, 163, 326, or 489 for a 978 data tone block, using an interleaver depth of 2, 4, 5, 7, 10, 14, 20, 28, 35, 49, 70, 98, 140, 196, 245, or 290 for a 980 data tone block, using an interleaver depth of 2 or 491 for a 982 data tone block, using an interleaver depth of 2, 3, 4, 6, 8, 12, 24, 41, 82, 123, 164, 246, 328, or 492 for a 984 data tone block, using an interleaver depth of 2, 17, 29, 34, 58, or 493 a 986 data tone block, using an interleaver depth of 2, 4, 13, 19, 26, 38, 52, 76, 247, or 494 for a 988 data tone block, or using an interleaver depth of 2, 3, 5, 6, 9, 10, 11, 15, 18, 22, 30, 33, 45, 55, 66, 90, 99, 110, 165, 198, 330 or 495 for a 990 data tone block.

In various embodiments, interleaving each sub-band can further include one or more of: using an interleaver depth of 2, 3, 4, 6, 8, 10, 12, 15, 16, 20, 24, 30, 32, 40, 48, 60, 64, 80, 96, 120, 160, 192, 240, 320, or 480 for a 960 data tone block, using an interleaver depth of 2, 13, 26, 37, 74, or 481 for a 962 data tone block, using an interleaver depth of 2, 4, 241, or 482 for a 964 data tone block, or using an interleaver depth of 2, 3, 6, 7, 14, 21, 23, 42, 46, 69, 138, 161, 322, or 483 for a 966 data tone block.

Then, at block 1230, the wireless device transmits the message. For example, the AP 104 can transmit the message to the STA 106.

In various embodiments, the method can further include transmitting 32, 33, 34, 36, or 37 pilot signals that change in frequency a number of times according to a sequence that repeats according to a channel interpolation factor of 2. For example, the AP 104 can transmit walking pilots as shown and discussed above with respect to FIG. 7.

In various embodiments, the method can further include transmitting 16 or fewer pilot signals that change in frequency a number of times according to a sequence that repeats according to a channel interpolation factor of 2 or greater. In various embodiments, the number of pilot signals can be 16 and the channel interpolation factor can be 4. For example, with reference to FIG. 6, the total number of pilot tones per symbol can be 16. Similarly, over a 16-symbol period, each pilot tone can visit only every 4^{th} tone.

In various embodiments, the method can further include boosting a transmit power of the pilot signals by a number of dB. In various embodiments, the number of dB can be 3 or 6.

In an embodiment, the methods shown in FIG. 12 can be implemented in a wireless device that can include a generating circuit, a performing circuit, and a transmitting circuit. Those skilled in the art will appreciate that a wireless device can have more components than the simplified wireless device described herein. The wireless device described herein includes components useful for describing some features of implementations within the scope of the claims.

The generating circuit can be configured to generate the message for transmission. In an embodiment, the generating circuit can be configured to implement block 1210 of the flowchart 1200 (FIG. 12). The generating circuit can include one or more of the encoder 1104 (FIG. 6), the DSP 220 (FIG. 2), the processor 204 (FIG. 2), the processor 1011 (FIG. 5), the memory 1012 (FIG. 5), and the memory 206 (FIG. 2). In some implementations, means for generating can include the generating circuit.

The performing circuit can be configured to perform interleaving. In an embodiment, the performing circuit can be configured to implement block 1220 of the flowchart 1200 (FIG. 12). The performing circuit can include one or more of the interleaver 1108 (FIG. 6), the interleaving system 1014 (FIG. 5), the DSP 220 (FIG. 2), the processor 204 (FIG. 2), and the memory 206 (FIG. 2). In some implementations, means for performing can include the performing circuit.

The transmitting circuit can be configured to provide the message for transmission.

In an embodiment, the transmitting circuit can be configured to implement block 1230 of the flowchart 1200 (FIG. 12). The transmitting circuit can include one or more of the transmitter 210 (FIG. 2), the transmitter 1110 (FIG. 6), the antenna 1112 (FIG. 6), the antenna 216 (FIG. 2), the transceiver 214 (FIG. 2), the processor 204 (FIG. 2), the DSP 220 (FIG. 2), and the memory 206 (FIG. 2). In some implementations, means for transmitting can include the transmitting circuit.

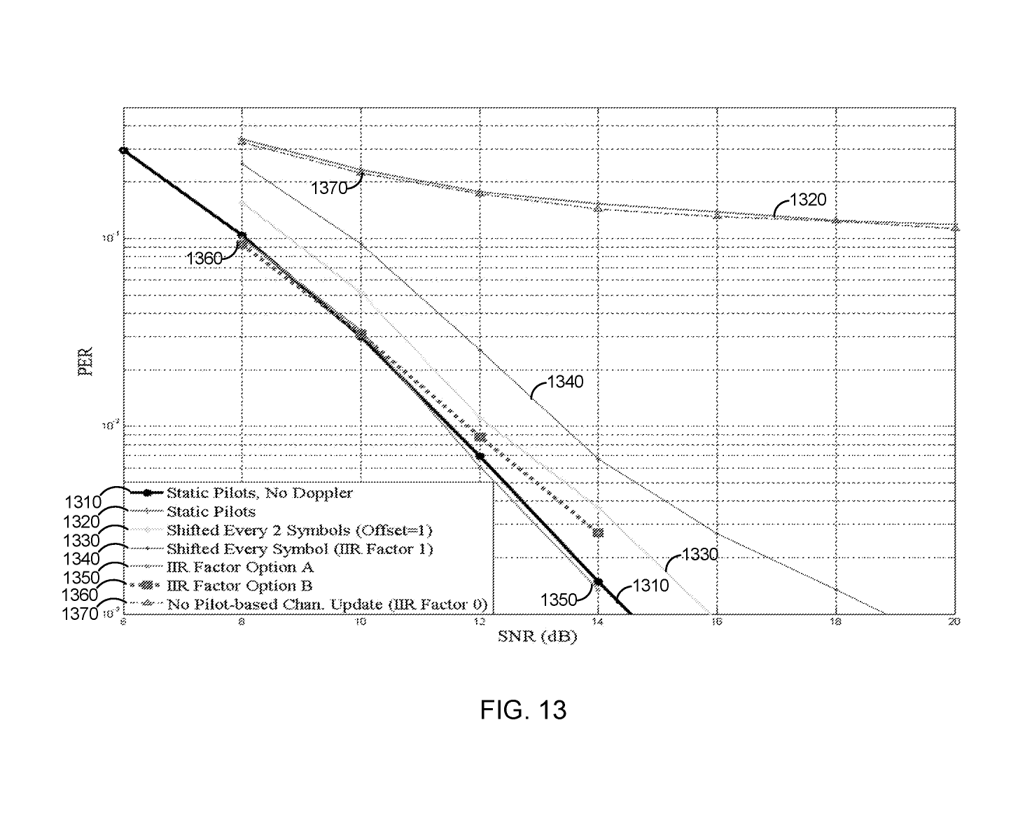

FIG. 13 shows a simulation of packet error rates (PER) according to various embodiments. In the illustration of FIG. 13, the x-axis represents a signal-to-noise ratio (SNR) in dB and the y-axis represents PER for various configurations 1310-1370. FIG. 13 depicts 802.11ah Doppler performance with and without walking pilots according to 4 MHz channel, MCSO, with a mobility of 60 km/h on a 4^{th} path, in 1500-byte packets (223 symbols), assuming a walking pilot periodicity of 760 μs (19 symbols). As can be see, walking pilots generally improve PER.

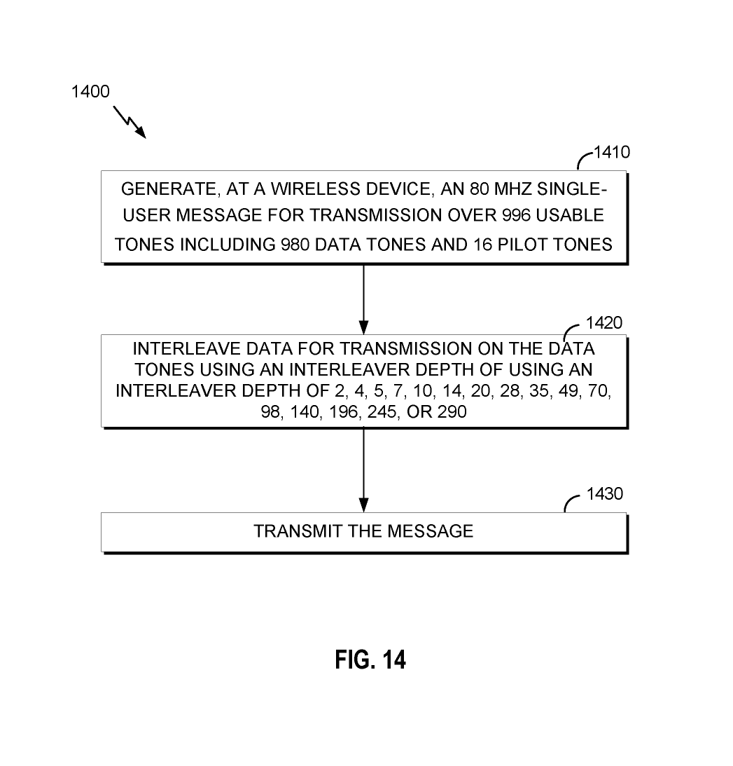

FIG. 14 shows a flowchart 1400 of another exemplary method of wireless communication that can be employed within the wireless communication system 100 of FIG. 1. The method can be implemented in whole or in part by the devices described herein, such as the AP 104 (FIG. 1), any of the STAs 106 (FIG. 1), the wireless device 202 shown in FIG. 2, the devices 1010, 1020, 1030, or 1040 (FIG. 10). Although the illustrated method is described herein with reference to the wireless communication system 100 discussed above with respect to FIG. 1, the wireless device 202 discussed above with respect to FIG. 2, the system 1000 of FIG. 5, a person having ordinary skill in the art will appreciate that the illustrated method can be implemented by another device described herein, or any other suitable device. Although the illustrated method is described herein with reference to a particular order, in various embodiments, blocks herein can be performed in a different order, or omitted, and additional blocks can be added.

First, at block 1410, a wireless device generates an 80 MHz single-user message for transmission over 996 usable tones including 980 data tones and 16 pilot tones. For example, the AP 104 can generate the message according to the 80 MHz SU tone plan discussed above with respect to Tables 1 and 2.

Next, at block 1420, the wireless device interleaves data for transmission on the data tones using an interleaver depth of using an interleaver depth of 2, 4, 5, 7, 10, 14, 20, 28, 35, 49, 70, 98, 140, 196, 245, or 290. For example, the AP 104 can interleave the message according to the parameters shown and discussed above with respect to FIGS. 4, 5, 8, and/or 9.

In various embodiments, the method can further include transmitting 16 pilot signals that change in frequency a number of times according to a sequence that repeats according to a channel interpolation factor of 2 or greater. For example, the AP 104 can transmit walking pilots as shown and discussed above with respect to FIG. 7. In various embodiments, the method can further include boosting a transmit power of the pilot signals by a number of dB.

In various embodiments, the number of dB can be 3 or 6. In various embodiments, the channel interpolation factor can be 4. In various embodiments, said interleaving can include a two-step interleaving process including distributing the data to a plurality of sub-bands, and separately interleaving each sub-band.

Then, at block 1430, the wireless device can transmit the message. For example, the AP 104 can transmit the message to the STA 106.

In various embodiments, the method can be performed by an access point (for example, AP 104) serving at least one mobile station (for example, STA 106A). A processor (for example, processor 204) and memory (for example, memory 206) of the access point can be configured to transmit the message to the mobile station through a transmitter (for example, transmitter 210) and antenna (for example, antenna 216) of the access point.

In various embodiments, the method can be performed by a station (for example, STA 106A) served by an access point (for example, AP 104). A processor (for example, processor 204) and memory (for example, memory 206) of the mobile device can be configured to transmit the message to the access point through a transmitter (for example, transmitter 210) and antenna (for example, antenna 216) of the mobile device.

In an embodiment, the methods shown in FIG. 14 can be implemented in a wireless device that can include a generating circuit, an interleaving circuit, and a transmitting circuit. Those skilled in the art will appreciate that a wireless device can have more components than the simplified wireless device described herein. The wireless device described herein includes components useful for describing some features of implementations within the scope of the claims.

The generating circuit can be configured to generate the message for transmission. In an embodiment, the generating circuit can be configured to implement block 1410 of the flowchart 1400 (FIG. 14). The generating circuit can include one or more of the encoder 1104 (FIG. 6), the DSP 220 (FIG. 2), the processor 204 (FIG. 2), the processor 1011 (FIG. 5), the memory 1012 (FIG. 5), and the memory 206 (FIG. 2). In some implementations, means for generating can include the generating circuit.

The interleaving circuit can be configured to perform interleaving. In an embodiment, the interleaving circuit can be configured to implement block 1420 of the flowchart 1400 (FIG. 14). The interleaving circuit can include one or more of the interleaver 1108 (FIG. 6), the interleaving system 1014 (FIG. 5), the DSP 220 (FIG. 2), the processor 204 (FIG. 2), and the memory 206 (FIG. 2). In some implementations, means for interleaving can include the interleaving circuit. In some implementations, means for distributing data to a plurality of sub-bands can include the interleaving circuit. In some implementations, means for separately interleaving each sub-band can include the interleaving circuit.

The transmitting circuit can be configured to provide the message for transmission. In an embodiment, the transmitting circuit can be configured to implement block 1430 of the flowchart 1400 (FIG. 14). The transmitting circuit can include one or more of the transmitter 210 (FIG. 2), the transmitter 1110 (FIG. 6), the antenna 1112 (FIG. 6), the antenna 216 (FIG. 2), the transceiver 214 (FIG. 2), the processor 204 (FIG. 2), the DSP 220 (FIG. 2), and the memory 206 (FIG. 2). In some implementations, means for transmitting can include the transmitting circuit. In some implementations, means for boosting a transmit power of the pilot signals by a number of dB can include the transmitting circuit.

A person/one having ordinary skill in the art would understand that information and signals can be represented using any of a variety of different technologies and techniques. For example, data, instructions, commands, information, signals, bits, symbols, and chips that can be referenced throughout the above description can be represented by voltages, currents, electromagnetic waves, magnetic fields or particles, optical fields or particles, or any combination thereof.

Various modifications to the implementations described in this disclosure can be readily apparent to those skilled in the art, and the generic principles defined herein can be applied to other implementations without departing from the spirit or scope of this disclosure. Thus, the disclosure is not intended to be limited to the implementations shown herein, but is to be accorded the widest scope consistent with the claims, the principles and the novel features disclosed herein. The word “exemplary” is used exclusively herein to mean “serving as an example, instance, or illustration.” Any implementation described herein as “exemplary” is not necessarily to be construed as preferred or advantageous over other implementations.

Certain features that are described in this specification in the context of separate implementations also can be implemented in combination in a single implementation. Conversely, various features that are described in the context of a single implementation also can be implemented in multiple implementations separately or in any suitable sub-combination. Moreover, although features can be described above as acting in certain combinations and even initially claimed as such, one or more features from a claimed combination can in some cases be excised from the combination, and the claimed combination can be directed to a sub-combination or variation of a sub-combination.

As used herein, a phrase referring to “at least one of a list of items refers to any combination of those items, including single members. As a first example, “at least one of a and b” (also “a or b”) is intended to cover a, b, and a-b, as well as any combination with multiples of the same element (e.g., a-a, a-a-a, a-a-b, a-b-b, b-b, b-b-b, or any other ordering of a and b). As a second example, “at least one of: a, b, and c” (also “a, b, or c”) is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

The various operations of methods described above can be performed by any suitable means capable of performing the operations, such as various hardware and/or software component(s), circuits, and/or module(s). Generally, any operations illustrated in the Figures can be performed by corresponding functional means capable of performing the operations.

The various illustrative logical blocks, modules and circuits described in connection with the present disclosure can be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor can be a microprocessor, but in the alternative, the processor can be any commercially available processor, controller, microcontroller or state machine. A processor can also be implemented as a combination of computing devices, e.g., a combination of a DSP and a microprocessor, a plurality of microprocessors, one or more microprocessors in conjunction with a DSP core, or any other such configuration.

In one or more aspects, the functions described can be implemented in hardware, software, firmware, or any combination thereof. If implemented in software, the functions can be stored on or transmitted over as one or more instructions or code on a computer-readable medium. Computer-readable media includes both computer storage media and communication media including any medium that facilitates transfer of a computer program from one place to another. A storage media can be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a web site, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Thus, in some aspects computer readable medium can comprise non-transitory computer readable medium (e.g., tangible media). In addition, in some aspects computer readable medium can comprise transitory computer readable medium (e.g., a signal). Combinations of the above should also be included within the scope of computer-readable media.

The methods disclosed herein comprise one or more steps or actions for achieving the described method. The method steps and/or actions can be interchanged with one another without departing from the scope of the claims. In other words, unless a specific order of steps or actions is specified, the order and/or use of specific steps and/or actions can be modified without departing from the scope of the claims.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

While the foregoing is directed to aspects of the present disclosure, other and further aspects of the disclosure can be devised without departing from the basic scope thereof, and the scope thereof is determined by the claims that follow.

What is claimed is:

1. A method of wireless communication, comprising:
generating, at a wireless device, an 80 MHz single-user message for transmission over 996 usable tones comprising 980 data tones and 16 pilot tones;
interleaving data for transmission on the data tones using an interleaver depth of using an interleaver depth of 2, 4, 5, 7, 10, 14, 20, 28, 35, 49, 70, 98, 140, 196, 245, or 290; and
transmitting the message.

2. The method of claim 1, further comprising transmitting 16 pilot signals that change in frequency a number of times according to a sequence that repeats according to a channel interpolation factor of 2 or greater.

3. The method of claim 2, further comprising boosting a transmit power of the pilot signals by a number of dB.

4. The method of claim 3, wherein the number of dB is 3 or 6.

5. The method of claim 3, wherein the channel interpolation factor is 4.

6. The method of claim 1, wherein said interleaving comprises a two-step interleaving process comprising:
distributing the data to a plurality of sub-bands; and
separately interleaving each sub-band.

7. The method of claim 1, wherein the method is performed by an access point serving at least one mobile station, wherein a processor and memory of the access point is configured to transmit the message to the mobile station through a transmitter and antenna of the access point.

8. The method of claim 1, wherein the method is performed by a mobile station served by an access point, wherein a processor and memory of the mobile device is configured to transmit the message to the access point through a transmitter and antenna of the mobile device.

9. An apparatus configured to provide wireless communication, comprising:
a memory that stores instructions;
a processor coupled with the memory, wherein the processor and the memory are configured to:
generate an 80 MHz single-user message for transmission over 996 usable tones comprising 980 data tones and 16 pilot tones; and
interleave data for transmission on the data tones using an interleaver depth of using an interleaver depth of 2, 4, 5, 7, 10, 14, 20, 28, 35, 49, 70, 98, 140, 196, 245, or 290; and
a transmitter configured to transmit the message.

10. The apparatus of claim 9, wherein the processor and the memory are further configured to transmit 16 pilot signals that change in frequency a number of times according to a sequence that repeats according to a channel interpolation factor of 2 or greater.

11. The apparatus of claim 10, wherein the processor and the memory are further configured to boost a transmit power of the pilot signals by a number of dB.

12. The apparatus of claim 11, wherein the number of dB is 3 or 6.

13. The apparatus of claim 11, wherein the channel interpolation factor is 4.

14. The apparatus of claim 9, wherein said interleaving comprises a two-step interleaving process, wherein the processor and the memory are further configured to:
distribute the data to a plurality of sub-bands; and
separately interleave each sub-band.

15. The apparatus of claim 9, wherein the apparatus comprises an access point serving at least one mobile station, wherein the processor and memory are configured to transmit the message to the at least one mobile station through the transmitter and an antenna of the access point.

16. The apparatus of claim 9, wherein the apparatus comprises a mobile station served by an access point, wherein the processor and memory are configured of the mobile device is configured to transmit the message to the access point through a transmitter and antenna of the mobile device.

17. An apparatus for wireless communication, comprising:
means for generating an 80 MHz single-user message for transmission over 996 usable tones comprising 980 data tones and 16 pilot tones;
means for interleaving data for transmission on the data tones using an interleaver depth of using an interleaver depth of 2, 4, 5, 7, 10, 14, 20, 28, 35, 49, 70, 98, 140, 196, 245, or 290; and
means for transmitting the message.

18. The apparatus of claim 17, further comprising means for transmitting 16 pilot signals that change in frequency a number of times according to a sequence that repeats according to a channel interpolation factor of 2 or greater.

19. A non-transitory computer-readable medium comprising code that, when executed, causes an apparatus to:
generate an 80 MHz single-user message for transmission over 996 usable tones comprising 980 data tones and 16 pilot tones;
interleave data for transmission on the data tones using an interleaver depth of using an interleaver depth of 2, 4, 5, 7, 10, 14, 20, 28, 35, 49, 70, 98, 140, 196, 245, or 290; and
transmit the message.

20. The medium of claim 19, further comprising code that, when executed, causes the apparatus to transmit 16 pilot signals that change in frequency a number of times according to a sequence that repeats according to a channel interpolation factor of 2 or greater.
